(19) United States
(12) Patent Application Publication
(10) Pub. No.: US 2026/0340341 A1
(43) Pub. Date: Oct. 29, 2026

(54) TECHNIQUES FOR IMPROVED CONCENTRATION LEVEL ANOMALY DETECTION WITHIN CHEMICAL SAMPLES

(71) Applicant: UCHICAGO ARGONNE, LLC, Chicago, IL (US)

(72) Inventors: Alexander Heifetz, Riverwoods, IL (US); Alexandra Akins, Garner, NC (US); Nathaniel C. Hoyt, Clarendon Hills, IL (US); Amber L. Polke, Mokena, IL (US)

(21) Appl. No.: 19/188,635

(22) Filed: Apr. 24, 2025

(51) Int. Cl. G06N 3/0442; G01N 27/30; G01N 27/416; G06N 3/0455; G06N 3/0985

(52) U.S. Cl. CPC G06N 3/0442; G01N 27/30; G01N 27/4166; G06N 3/0455; G06N 3/0985

(57) ABSTRACT

Techniques for improved anomaly detection within electrochemical data are provided herein. An example system includes memories storing executable instructions; and processors configured to execute the executable instructions. Executing the instructions may cause the system to receive electrochemical data corresponding to concentration levels of a chemical sample and apply an autoencoder to the electrochemical data to determine whether the electrochemical data includes an anomaly related to the chemical sample. The autoencoder may have one or more long short-term memory (LSTM) neurons. The instructions may further cause the system to, responsive to determining that the electrochemical data includes the anomaly, generate an alert for display to a user. The alert may indicate that the anomaly is present within the electrochemical data.

### STATEMENT REGARDING FEDERALLY SPONSORED RESEARCH OR DEVELOPMENT

This invention was made with government support under Contract No. DE-AC02-06CH11357 awarded by the United States Department of Energy to UChicago Argonne, LLC, operator of Argonne National Laboratory. This invention was partially funded by ARPA-E DE-AROOOO1606 under WAS #21/CJ000/01/04 project. The government has certain rights in the invention.

### TECHNICAL FIELD

The present disclosure generally relates to concentration level anomaly detection within chemical samples. The techniques described herein apply an autoencoder with long short-term memory (LSTM) neurons to electrochemical data corresponding to concentration levels of a chemical sample to detect anomalies related to the chemical sample and generate alerts for such anomalies.

### BACKGROUND

Many existing techniques for anomaly detection in electrochemical systems face significant challenges and accordingly suffer from notable drawbacks. For example, material accountancy in molten salt fuel reprocessing systems experience high temperatures, corrosivity, complex fluid mixtures, and/or fluxes creating variable/unreliable measurement environments. Existing methods for monitoring and analyzing these systems often rely on electrochemical sensors using techniques such as linear sweep voltammetry (LSV) to measure actinides dissolved within the process salts. However, the accuracy of these measurements is frequently compromised by, e.g., changing effective surface area of the measurement electrode(s) due to material deposition, which can obfuscate/skew the material balances measured by the electrode(s).

Such issues create significant drawbacks as they undermine the reliability and accuracy of measurements necessary for ensuring the safety and efficiency of reprocessing operations. The inability to obtain precise and consistent data directly impacts the effectiveness of anomaly detection systems, potentially leading to undetected anomalies that could have serious implications for operational integrity.

### SUMMARY OF THE DISCLOSURE

In some aspects, the techniques described herein relate to a system for improved anomaly detection, including: one or more memories storing executable instructions; and one or more processors configured to execute the executable instructions to cause the system to: receive electrochemical data corresponding to concentration levels of a chemical sample, apply an autoencoder to the electrochemical data to determine whether the electrochemical data includes an anomaly related to the chemical sample, the autoencoder having one or more LSTM neurons, and responsive to determining that the electrochemical data includes the anomaly, generate an alert for display to a user, the alert indicating that the anomaly is present.

In some aspects, the techniques described herein relate to a method for improved anomaly detection, including: receiving, by one or more processors, electrochemical data corresponding to concentration levels of a chemical sample; applying, by the one or more processors, an autoencoder to the electrochemical data to determine whether the electrochemical data includes an anomaly related to the chemical sample, the autoencoder having one or more LSTM neurons; and responsive to determining that the electrochemical data includes the anomaly, generating, by the one or more processors, an alert for display to a user, the alert indicating that the anomaly is present.

In some aspects, the techniques described herein relate to a non-transitory computer-readable medium, including executable instructions that, when executed by one or more processors, cause the one or more processors to perform actions including: receiving electrochemical data corresponding to concentration levels of a chemical sample; applying an autoencoder to the electrochemical data to determine whether the electrochemical data includes an anomaly related to the chemical sample, the autoencoder having one or more LSTM neurons; and responsive to determining that the electrochemical data includes the anomaly, generating an alert for display to a user, the alert indicating that the anomaly is present.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1 depicts an example computing system in which various embodiments of the present disclosure may be implemented.

FIG. 2 depicts an example overview of the anomaly detection techniques described herein, in accordance with various embodiments described herein.

FIG. 3 depicts multiple LSV curves representing electrochemical data acquired at different depths within a fuel reprocessing tank, in accordance with various embodiments described herein.

FIG. 4 depicts electrochemical data from multiple electrodes being input into an LSTM autoencoder configured to determine whether the data includes an anomaly, in accordance with various embodiments described herein.

FIG. 5A depicts a first example loss density distribution curve at a first voltage value for the techniques described herein, in accordance with various embodiments described herein.

FIG. 5B depicts a second example loss density distribution curve at a second voltage value for the techniques described herein, in accordance with various embodiments described herein.

FIG. 6A depicts an example uncertainty quantification technique utilizing Monte Carlo (MC) dropout to obtain a distribution of autoencoder networks, in accordance with various embodiments described herein.

FIG. 6B depicts another example uncertainty quantification technique, in accordance with various embodiments described herein.

FIG. 7A is a graph illustrating a first example comparison of a test loss corresponding to normal data to an anomaly detection threshold, in accordance with various embodiments described herein.

FIG. 7B is a graph illustrating a second example comparison of a test loss corresponding to anomalous data to the anomaly detection threshold, in accordance with various embodiments described herein.

FIG. 8 includes two graphs depicting an example test loss compared to an anomaly detection threshold across an entire voltage range and across an interval of the entire voltage range, in accordance with various embodiments described herein.

FIG. 9 is a graph illustrating the false positive rate and the true positive rate associated with anomaly detection performed using an LSTM autoencoder and principal component analysis (PCA), in accordance with various embodiments described herein.

FIG. 10 depicts an example workflow for generating alerts, recommendations, and/or control instructions in response to determining that electrochemical data includes an anomaly, in accordance with various embodiments described herein.

FIG. 11 depicts a flow diagram representing an example computer-implemented method, in accordance with various embodiments described herein.

### DETAILED DESCRIPTION

The present techniques generally improve anomaly detection for electrochemical data by overcoming challenges existing techniques face when monitoring and analyzing concentration levels of chemical samples in complex environments (e.g., molten salt fuel reprocessing systems). Such existing techniques face significant challenges due to high temperatures, corrosivity, complex fluid mixtures, and/or complex material fluxes, among others, making material accountancy and anomaly detection particularly challenging tasks. The present techniques address these (and other) challenges by leveraging machine learning (IL), such as an autoencoder with LSTM neurons, to provide robust anomaly detection capabilities for electrochemical data (e.g., LSV measurements).

In particular, the present techniques apply an autoencoder having LSTM neurons to electrochemical data to determine whether the data includes an anomaly, and responsive to determining an anomaly exists, generate an alert for display to a user indicating that the anomaly is present. As an initial matter, the present techniques improve over existing techniques at least because it is a data-driven approach that eliminates much of the variability present in existing techniques that are largely dependent on detailed knowledge of experimental parameters that can change over time. Existing techniques often require precise control and understanding of various experimental parameters (e.g., electrode surface area) to ensure accuracy in measurements, which as mentioned, can be challenging due to the dynamic and harsh environmental conditions (e.g., molten salt fuel reprocessing environments). In contrast, utilizing an autoencoder with LSTM neurons to analyze electrochemical data allows the present techniques to learn from the data itself, identifying patterns and anomalies without the need for explicit knowledge of the underlying parameters. As a result, the present techniques are more adaptable and robust than existing techniques, capable of detecting anomalies in a wide range of conditions without the limitations imposed by the variability of physical parameters.

Moreover, the autoencoder configuration of the present techniques is more accurate than existing techniques that may utilize some form of data-driven analysis through the implementation of LSTM neurons. Many existing ML techniques rely on less sophisticated ML models that do not adequately address the complexities of electrochemical data, especially when considering significant shifts in peak voltage locations and the need for sensitivity to peak current changes that can be present in vast datasets. The LSTM autoencoder of the present techniques is particularly well-suited for this application due to its ability to learn from unlabeled data through a process of compression and expansion. This process involves running electrochemical data through increasingly smaller layers of neurons in the encoder, then expanding the data back out in the decoder, effectively forcing the autoencoder to learn the essential features of the data. Such dimensionality reduction can be important for electrochemical data analysis, where certain data characteristics must be identified from large datasets without sacrificing processing efficiency. Many existing techniques lack such dimensionality reduction capabilities altogether or suffer from low anomaly detection accuracy resulting from ill-suited dimensionality reduction techniques. Therefore, the autoencoder of the present techniques improves upon such existing techniques by effectively reducing the dimensionality of input electrochemical data without sacrificing the relevant data characteristics or processing efficiency.

Further, the LSTM neurons are generally more adept at handling time-series data and capturing long-term dependencies within the data than existing techniques. Electrochemical data often contains temporal characteristics that are indicative of the chemical sample's state, such that LSTM neurons are well suited to accurately characterizing normal/anomalous electrochemical data patterns. Moreover, the LSTM neurons are a type of recurrent neural network (RNN) designed to access long-term memory and consequently address the challenges typically faced by existing RNNs. The neurons do so by incorporating gates that allow the network to selectively ignore parts of the data that are not relevant, thereby avoiding the common pitfalls of RNNs such as the vanishing gradient problem. Thus, the LSTM neurons make the LSTM autoencoder of the present techniques more adept at handling time-series data (e.g., electrochemical data) than existing techniques, and thereby improve anomaly detection accuracy relative to such existing techniques at least by reducing the effects of time-series analysis issues commonly experienced by existing techniques.

Overall, the benefits of the present techniques are manifold, including enhanced anomaly detection accuracy, improved processing efficiency, and optimized memory usage, such that the present techniques thereby represent a substantial improvement at least in the functioning of a computer or computing device. By leveraging LSTM neurons in an autoencoder configuration, the present techniques can accurately determine anomalies present within time-series data (e.g., electrochemical data) to an extent existing techniques are typically unable to re-create. These LSTM neurons are also capable of processing electrochemical data, and thereby identifying anomalies within such data, more efficiently than existing techniques. This efficiency is particularly beneficial in environments where timely anomaly detection is critical for maintaining operational safety and efficiency (e.g., molten salt fuel reprocessing systems). Additionally, the present system's ability to compress and decompress electrochemical data effectively reduces memory usage, as it focuses on certain features of the data, thereby minimizing the storage requirements for large datasets. Accordingly, the present techniques represent a significant improvement to the functioning of a computer or computing device at least by causing such computer/computing device to perform anomaly detection substantially more efficiently and accurately than existing techniques.

The described techniques also represent a practical application of the concepts embodied therein at least by accurately and efficiently determining anomalies and issuing corresponding alerts/recommendations. These alerts enable more timely resolution of issues represented by the anomalies, which can be particularly relevant in environments such as molten salt fuel reprocessing systems where operational safety and efficiency are paramount. The ability to generate alerts upon detecting anomalies allows users to quickly identify and address potential issues, reducing the risk of operational disruptions or safety hazards. Such an immediate feedback mechanism thereby facilitates proactive maintenance and decision-making processes. Moreover, in embodiments where the alerts include recommendations related to resolving the anomaly, the present techniques empower these users to take specific, informed actions to investigate and mitigate the anomaly's underlying causes. This capability can be particularly relevant in complex chemical processing environments, where understanding and responding to anomalies can prevent costly downtime, ensure compliance with regulatory standards, and maintain the integrity of the processing system. Thus, alerts generated as part of the present techniques represent a practical application of the disclosed anomaly detection concepts by directly improving the operational safety, efficiency, and reliability within challenging environments (e.g., molten salt fuel reprocessing systems).

Still further, the present disclosure includes specific features other than what is well-understood, routine, conventional activity in the field, or adding unconventional steps that demonstrate, in various embodiments, particular useful applications, e.g., applying an autoencoder to the electrochemical data to determine whether the electrochemical data includes an anomaly related to the chemical sample, the autoencoder having one or more LSTM neurons, and responsive to determining that the electrochemical data includes the anomaly, generating an alert for display to a user, the alert indicating that the anomaly is present, among others.

In certain embodiments, the present techniques further employ a semi-supervised learning approach, where it is trained on a set of non-anomalous electrochemical data, and thereby improve anomaly detection accuracy relative to existing techniques. This particular training configuration enables the present techniques to establish a baseline of normal operation for the electrochemical system, against which it can compare new data to identify anomalies.

The present techniques may then determine an anomaly detection threshold based on the distribution of loss function values, allowing for the dynamic adjustment of the threshold as a hyperparameter of the autoencoder. This adaptability helps maintain high sensitivity to anomalies while minimizing false positives, especially in the complex and variable conditions encountered in many environments (e.g., molten salt fuel reprocessing systems).

Further, in some embodiments, the present techniques incorporate dropout layers between LSTM neuron layers to further refine the system's performance by enabling uncertainty quantification through a MC dropout process. Such a dropout process allows the present techniques to iteratively apply the autoencoder to electrochemical data, utilizing different subsets of LSTM neurons to determine a predictive distribution of the autoencoder. By analyzing various values (e.g., mean, variance) of this distribution, the present techniques can more accurately determine the anomaly detection threshold, further enhancing the present techniques' ability to detect anomalies with greater confidence than existing techniques.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the context of molten salt fuel reprocessing and associated systems, the techniques described herein may be readily applied in any suitable field for any suitable purpose.

### Example Computing System

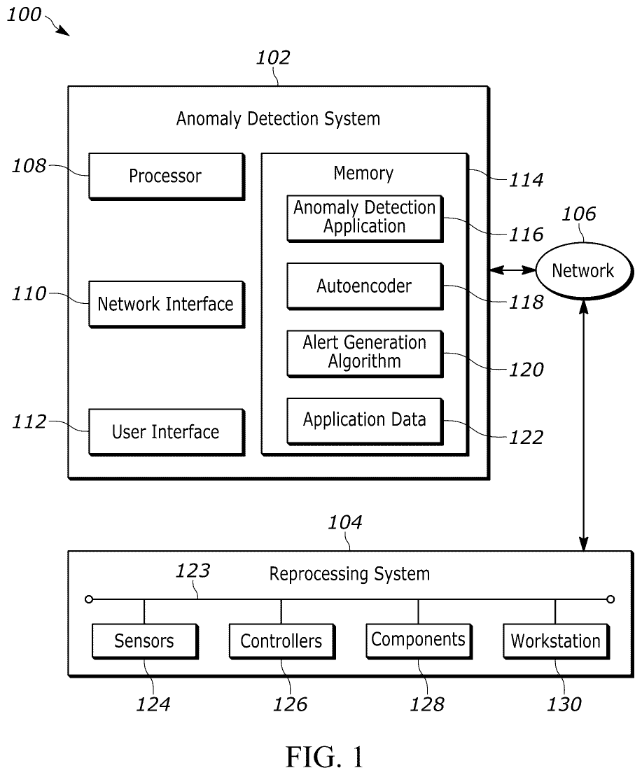

FIG. 1 depicts an example computing system 100 in which various embodiments of the present disclosure may be implemented. Depending on the embodiment, the example computing system 100 may determine whether electrochemical data includes an anomaly, generate alerts for display to a user, determine loss function values, determine threshold values, generate recommendations as part of the alerts, and/or perform any other actions associated with any related values or combinations thereof. Of course, it should be appreciated that, while the various components of the example computing system 100 (e.g., anomaly detection system 102, reprocessing system 104) are illustrated in FIG. 1 as single components, the example computing system 100 may include multiple (e.g., dozens, hundreds, thousands) of anomaly detection systems 102 that are simultaneously connected to the network 106 at any given time to service a single reprocessing system 104 and/or multiple reprocessing systems 104 connected to a single/multiple anomaly detection systems 102 through the network 106.

Generally, the example computing system 100 includes an anomaly detection system 102, a reprocessing system 104, and a network 106. The anomaly detection system 102 and the reprocessing system 104 may communicate with the other devices (e.g., transmit data, instructions, etc.) across the network 106. As an example, the reprocessing system 104 and the anomaly detection system 102 may belong to an entity that provides fuel reprocessing services. In this example, the reprocessing system 104 may transmit data (e.g., electrochemical data including LSV data) to the anomaly detection system 102, and the system 102 may execute an anomaly detection application 116 to analyze the data, determine whether the data includes an anomaly, and if the data contains an anomaly, generate alerts to users (e.g., at the workstation 130). The anomaly detection system 102 may make any such alerts and/or the outputs of the electrochemical data analysis accessible to a user/operator via at the reprocessing system 104, so the user may review the data analysis and any alerts contained therein, perform any recommended remediation actions, and/or any other suitable actions or combinations thereof.

As one example, the reprocessing system 104 may be a molten salt fuel reprocessing system that operates to recycle spent nuclear fuel. The reprocessing system 104 may receive spent nuclear fuel and utilize various components 128 to dissolve the spent nuclear fuel into a molten salt mixture. The controllers 126 and the components 128 may then subject the mixture to chemical processes that separate valuable fissile materials, such as uranium and plutonium, from waste products and other non-fissile materials. The fissile materials can be recycled back into the nuclear fuel cycle for reuse in reactors, while the waste products are solidified and prepared for safe disposal, thereby reducing the amount of waste and the need for new uranium mining.

More specifically, the anomaly detection system 102 may include one or more processors 108, a networking interface 110, a user interface 112, and one or more memories 114. The one or more memories 114 may store executable instructions that are configured to, when executed by the one or more processors 108, cause the one or more processors 108 to analyze data (e.g., electrochemical data received from the reprocessing system 104) received at the anomaly detection system 102 and output various values (e.g., an alert indicating a detected anomaly). The anomaly detection application 116, the autoencoder 118, the alert generation algorithm 120, and the application data 122 may all comprise such executable instructions, as well as other data. The memory 114 may additionally or alternatively store additional data and/or databases. It should be appreciated that the anomaly detection system 102 can include one or multiple computing devices that are co-located or distributed.

The anomaly detection system 102 may receive electrochemical data from the reprocessing system 104 connected to the system 102 through the network 106 and process the electrochemical data in accordance with one or more sets of instructions stored in the one or more memories 114 to perform any of the actions and/or output any of the values described herein. The anomaly detection system 102 may execute the anomaly detection application 102d, which in turn, may access and apply one or more of the autoencoder 118, the alert generation algorithm 120, and/or the application data 122 to the received electrochemical data.

Generally, the electrochemical data may represent physical parameters of a chemical sample that is involved in the processes performed by the reprocessing system 104. For example, the electrochemical data may indicate concentrations of actinides (e.g., uranium) within a molten salt sample of the reprocessing system 104. Such data may be derived from LSV measurements, which may involve applying time-dependent voltage waveforms to an electrolytic cell and recording the resulting diffusion current to ascertain redox potentials and concentrations of chemical species present in the chemical sample. Each dataset included as part of the electrochemical data may comprise current-voltage (I-V) curves, which may enable the anomaly detection application 116 to identify concentrations of uranium at various weight percentages within the molten salt sample.

The anomaly detection application 116 may receive this electrochemical data and orchestrate the anomaly detection analysis by inputting the data into the autoencoder 118. In certain embodiments, the autoencoder 118 may be an LSTM autoencoder that is adept at handling time-series data and capturing long-term dependencies within data (e.g., the electrochemical data). This LSTM autoencoder 118 may operate by compressing the input electrochemical data through a series of progressively smaller neural network layers (e.g., an encoder) that remove portions of the data that are unrelated to the temporal characteristics of the data. The autoencoder 118 may then reconstruct the data to its original dimensionality through a reverse process (e.g., a decoder) that includes incorporating predicted data points into the compressed data.

This compression/decompression process may enable the distillation of relevant features within the electrochemical data, facilitating the detection of anomalies that may indicate deviations from normal operational parameters, such as unexpected drops in uranium concentration. Namely, when the autoencoder 118 has successfully compressed and decompressed the electrochemical data, the autoencoder 118 may determine a loss function value for each data point in the electrochemical data by comparing the original data (e.g., uncompressed) with analogous points in the decompressed data. This loss function value may be any suitable value, such as a mean absolute error value (MAE), as defined below:

$$MAE = \frac{1}{n} {\sum }_{i = 1}^{n} \vert {\hat{Y}}_{i} - {Y}_{i} \vert , \qquad ( 1 )$$

where Ŷᵢ is the prediction and Yᵢ is the true value from the input electrochemical data.

Such an MAE value may provide a direct measure of average error, which may be particularly useful in the context of anomaly detection, as it may ensure that all errors are weighted equally, making MAE substantially sensitive to outliers. As an example, the mean squared error (MSE) tends to diminish the impact of outliers by squaring the errors, such that it may underrepresent the significance of anomalies in the data. On the other hand, MAE, by treating all deviations from the mean equally, may allow for more accurate identification of anomalies. In certain embodiments, the loss function value may be or otherwise correspond to at least one of: (i) an MAE value, (ii) an MSE value, (iii) a binary cross-entropy loss value, (iv) a mean squared logarithmic error (MSLE) value, (v) a categorical cross-entropy loss value, (vi) a Huber loss value, (vii) a cosine similarity loss value, (viii) a Kullback-Liebler (KL) divergence value, and/or any other suitable value or combinations thereof.

With the loss function values, the anomaly detection application 116 may execute the alert generation algorithm 120 to determine whether an alert should be generated and what the alert should comprise. The alert generation algorithm 120 may determine whether the loss function value(s) exceed and/or otherwise fail to satisfy an anomaly detection threshold, and if so, may determine that an anomaly is present within the electrochemical data, such that an alert should be generated. Depending on the circumstances of the anomaly, the algorithm 120 may cause the application 116 to include various recommendations as part of the alert indicating, for example, where the anomaly is likely occurring, a cause of the anomaly, predicted consequences of the anomaly, time available to remedy the anomaly, remediation actions users may take to likely resolve the anomaly, and/or any other additional information or combinations thereof.

As an example, the anomaly detection application 116 may monitor the electrochemical processes in a molten salt fuel reprocessing system (e.g., reprocessing system 104), and the application 116 may utilize an MAE-based loss function to detect deviations from expected operational parameters. Suppose the application 116 continuously analyzes electrochemical data, including diffusion current as a function of applied voltage, to ensure the system operates within established norms. During an example analysis, the anomaly detection application 116 may execute the autoencoder 118 to generate a decompressed data set and may execute the alert generation algorithm 120 to calculate the MAE for the latest set of data to compare it against a predefined anomaly detection threshold (e.g., six standard deviations from the mean). Upon detecting that the MAE value exceeds this anomaly detection threshold, the alert generation algorithm 120 may cause the anomaly detection application 116 to determine that an anomaly is present within the electrochemical data and generate an alert to notify relevant personnel or systems.

Specifically in this example, the application 116 may detect an unusual spike in the MAE value for the diffusion current data, which significantly exceeds the predefined anomaly detection threshold of six standard deviations from the mean. This deviation may trigger the alert generation algorithm 120, which then analyzes the electrochemical data to identify the nature and implications of the detected anomaly. The algorithm 120 may cause the application 116 to generate an alert that indicates the anomaly is located in the electrochemical separation unit of the reprocessing system. The alert may also suggest that the cause of the anomaly could be a leak in the containment vessel, leading to contamination of the molten salt with impurities, which may alter the electrochemical properties of the salt, as reflected in the abnormal diffusion current data.

To address this anomaly, the algorithm 120 may cause the application 116 to include recommendations in the alert. These recommendations may comprise conducting a thorough inspection of the containment vessel for any signs of leakage or damage, analyzing samples of the molten salt for impurities that could have altered its electrochemical behavior, and/or if contamination is confirmed, replacing the contaminated salt and repairing the leak to prevent further issues. Additionally, the algorithm 120 may cause the application 116 to generate an alert that indicates adjusting operational parameters temporarily to stabilize the reprocessing system 104 until the issue is resolved, and/or implementing enhanced monitoring protocols to closely watch for similar anomalies in the future, thereby preventing potential system failures or safety hazards. Further, the alert may emphasize the urgency of these remediation actions, providing a specific timeframe for their completion to mitigate the risk of significant operational disruptions or safety concerns. The alert may also underscore the importance of further analysis to understand the root cause of the anomaly, ensuring the long-term reliability and safety of the reprocessing system 104.

The anomaly detection threshold may generally correspond to known difference values between received electrochemical data and the decompressed versions of such data that is based on data corresponding to “normal” operating conditions of the reprocessing system 104. For example, the anomaly detection application 116 may determine the anomaly detection threshold and may set the anomaly detection threshold at six standard deviations away from a known loss function value and/or a distribution of such loss function values. Setting the anomaly detection threshold at six standard deviations may acknowledge the presence of outliers beyond the expected 99.7% of data within three standard deviations of the mean. Any or all of the detected anomalies, alerts, electrochemical data, and/or any other data received by the anomaly detection system 102 and/or output by the system 102 may be stored as part of the application data 122.

The reprocessing system 104 may generally include components 128 configured to perform a process (e.g., molten salt fuel reprocessing process), sensors 124 configured to monitor the components 128 and measurable quantities of the process, controllers 126 to control the components 128 and/or sensors 124, and an operator workstation 130 for system operators to input requests, view measured data, respond to alerts, and/or otherwise interact with the controllers 126 and/or the anomaly detection system 102. The anomaly detection system 102 is generally configured to receive operating data (e.g., sensor data) from the reprocessing system 104 to determine anomalies associated with chemical samples processed by the reprocessing system 104 and to determine alerts/recommendations associated with the determined anomalies.

The various parts of the reprocessing system 104 may be communicatively connected via wired or wireless connections to a data bus 123. The data bus 123 may in turn by communicatively connected to the anomaly detection system 102 via the network 106. As mentioned, the reprocessing system 104 includes components 128 (e.g., pumps, valves, heat exchangers, heaters, condensers, pipes, junctions, motors, etc.) and sensors 124. In some embodiments, the components 128 may include only a single component (or only a single component of the components 128 may be analyzed). The sensors 124 may monitor conditions of the reprocessing system 104 as a whole or may monitor parameters of the components 128 (e.g., flow rate, temperature, pressure, etc.). The sensors 124 may be affixed onto the components 128 or be installed within or be part of the components 128.

The reprocessing system 104 also includes one or more controllers 126 including control circuitry for controlling the components 128 and the sensors 124. For example, the controllers 126 may control the activation and/or deactivation and modify settings of the components 128 and the sensors 124. Further, the controllers 126 may modify notification settings of the sensors 124 (e.g., what information the sensors 124 provide to the data bus 123 and at what times). The controllers 126 may transmit data and instructions to the components 128 and the sensors 124 via the data bus 123, and may receive information (e.g., responses to the instructions, measurements from the sensors 124) from the components 128 and the sensors 124 via the data bus 123. The controllers 126 also may provide data (e.g., data exchanged with parts of the reprocessing system 104) to the data bus 123. This data may include indications of parts of the reprocessing system 104 that are activated or deactivated (e.g., including timestamps), as well as indications of controlled settings and indications of instances in which controlled settings are modified (e.g., including timestamps).

A user, such as a system operator, may issue instructions to the controllers 126 and monitor information received from the data bus 123 (e.g., from the controllers 126, components 128, or the sensors 124) via an operator workstation 130. The operator workstation 130 may be a personal computer, a laptop, a smartphone, a tablet, a wearable portable device, etc. Generally, the operator workstation 130 may include a processor, a memory, a network interface, and a user interface (e.g., including a display and user inputs), similar to the anomaly detection system 102. The reprocessing system 104 may include multiple operator workstations 130 and/or multiple controllers 126. For example, each system component of the components 128 may be associated with a different controller or controllers. Each controller may be associated with one operator workstation, or an operator workstation can be used to configure multiple controllers. The anomaly detection system 102 can transmit responses to operator requests/queries, fault diagnoses, and/or other output data to the operator workstation, which can display, present, or process the responses, fault diagnoses, and/or output data. Likewise, the operator workstation 130 can manage transmission of input data from the reprocessing system 104 to the anomaly detection system 102.

In some embodiments, the anomaly detection system 102 is a server or collection of servers hosting the application data 122 or a portion thereof, e.g., since the application data may comprise electrochemical data of multiple processes received from the reprocessing system 104 and/or different reprocessing systems. The anomaly detection system 102 may be communicatively coupled to the reprocessing system 104 via any suitable communication protocol(s). For example, the anomaly detection system 102 and the reprocessing system 104 may communicate via USB, Bluetooth, Wi-Fi Direct, Near Field Communication (NFC), a private or public network (e.g., via an Internet protocol, such as IPv4, via a virtual private network (VPN)), etc. For example, the reprocessing system 104 may transmit electrochemical data and/or any other data to the anomaly detection system 102 via the network 106, which the anomaly detection system 102 may receive via the networking interface 110.

The processors 108 may include any suitable number of processors and/or processor types. For example, the processors 108 may include one or more CPUs and one or more graphics processing units (GPUs). Generally, the processors 108 may be configured to execute software instructions stored in the corresponding memories 114. The memories 114 may include one or more persistent memories (e.g., a hard drive and/or solid-state memory) and may store one or more applications, modules, and/or models, such as the anomaly detection application 116.

The networking interface 110 may enable the anomaly detection system 102 to communicate with the reprocessing system 104. The networking interface 110 may support one or more of the communication/network protocols implemented by the network 106. The networking interface 110 may enable the anomaly detection system 102 to communicate with the various components of the reprocessing system 104 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

Moreover, the network 106 may be a single communication network, or may include multiple communication networks of one or more types (e.g., one or more wired and/or PANs or LANs, and/or one or more WANs such as the Internet). In some embodiments, the network 106 includes multiple, entirely distinct networks.

It will be understood that the above disclosure is one example and does not necessarily describe every possible embodiment. As such, it will be further understood that alternate embodiments may include fewer, alternate, and/or additional steps or elements.

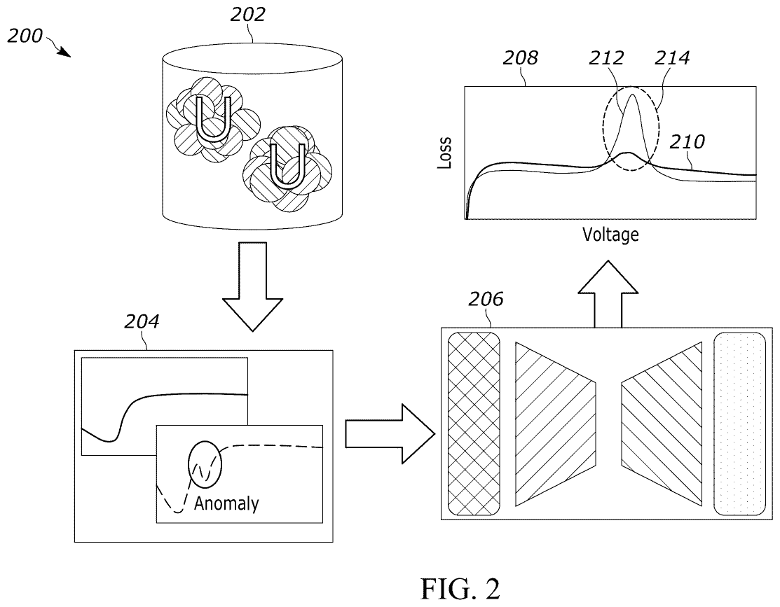

FIG. 2 depicts an example overview of the anomaly detection techniques described herein, in accordance with various embodiments described herein. In particular, FIG. 2 provides a graphical representation of the workflow 200 for ML-based anomaly detection in LSV data. At a high level, a chemical sample 202 is processed at a processing system (e.g., reprocessing system 104) that may generate various datasets 204 related to the chemical sample 202. These datasets 204 are used as inputs into an autoencoder 206 that determines an output 208 indicating whether an anomaly is present within the datasets 204.

For example, the datasets 204 may be the result of LSV techniques applied to spent nuclear fuel samples, such as uranium. Generating the datasets 204 may include molten salt reprocessing of a uranium sample, which is then subjected to LSV analysis. This analysis yields the datasets 204 that encapsulate the electrochemical behavior of the uranium sample, including current-voltage (I-V) curves that reflect the redox processes occurring within the chemical sample 202. These datasets 204 may thereby contain detailed information on the peak current values, peak potential values, and/or the shapes of the I-V curves. The autoencoder 206 may receive these datasets 204 as input and may be trained to recognize the normal patterns and features within such electrochemical data of chemical (e.g., uranium) samples 202. When the autoencoder 206 analyzes a dataset that deviates significantly from the established normal values, such as unexpected shifts in peak potentials, abnormal peak current values, or unusual shapes of the I-V curves, the autoencoder 206 may flag these deviations as anomalies. These anomalies could indicate, e.g., issues such as impurities in the uranium sample, unexpected presence of certain chemical species, and/or deviations in the electrochemical environment during the LSV measurement.

In any event, the machine learning approach may be a semi-supervised compression learning (CL) process, wherein the autoencoder 206 is trained using data that is known/labeled as representing “normal” LSV data for chemical samples of various concentrations. Using this training data, the systems described herein may train the autoencoder 206 through the iterative compression and decompression of data. During this process, the autoencoder 206 may learn the relevant features representing the training data and determine a loss function as the difference between the decompressed data and the original (input) data. It should be appreciated that the training data may be different from the datasets 204 illustrated in FIG. 2, which include at least one dataset having an anomaly.

In certain embodiments, this training process may involve the generation of compression and decompression mappings for the autoencoder 206 to maintain the relevant features of any input data. These embodiments may include training the autoencoder 206 using a set of non-anomalous electrochemical data that causes the autoencoder 206 to determine (i) a compression mapping for an encoder of the autoencoder 206 representing weight adjustments to the LSTM neurons of the encoder and (ii) a decompression mapping for a decoder of the autoencoder 206 representing weight adjustments to the LSTM neurons of the decoder. Up to each weight adjustment to the LSTM neurons may correspond to a loss function value from comparing a data point input into the encoder to an output data point from the decoder.

The specific implementations of compression learning described herein may be carried out using an LSTM autoencoder. An LSTM autoencoder is generally a type of neural network that incorporates LSTM neurons within an autoencoder architecture. This architecture is designed to handle sequences of data, making it particularly suitable for analyzing LSV data (e.g., datasets 204), which involves measurements taken over time.

As an example, the LSTM autoencoder may be trained using labeled LSV data that includes a range of uranium weight concentrations in molten salt. In this manner, the autoencoder 206 may learn to recognize the normal patterns of uranium concentrations within the electrochemical data. An anomaly, in this context, may be an LSV measurement for uranium concentration that is lower than those included in the training database. The LSTM autoencoder 206 may identify these anomalies by comparing the decompressed data, which generally represents the model's understanding of normal patterns, with the original data. If the decompressed data significantly deviates from the original data, the systems described herein may flag the data as anomalous.

The example output 208 provides an example of such anomalous data, wherein the anomalous data loss values 212 exceed the threshold loss values 210 in a voltage region 214.

The anomaly within the voltage region 214 may have various characteristics, such as a magnitude to which the anomalous data loss values 212 exceed the threshold loss values 210 and/or a voltage range, across which, the anomalous data loss value 212 exceed the threshold loss values 210. Based on these characteristics, the systems described herein (e.g., alert generation algorithm 120) may determine/generate alerts/recommendations that describe the anomaly and/or remediation actions to be taken to resolve the conditions causing the anomaly.

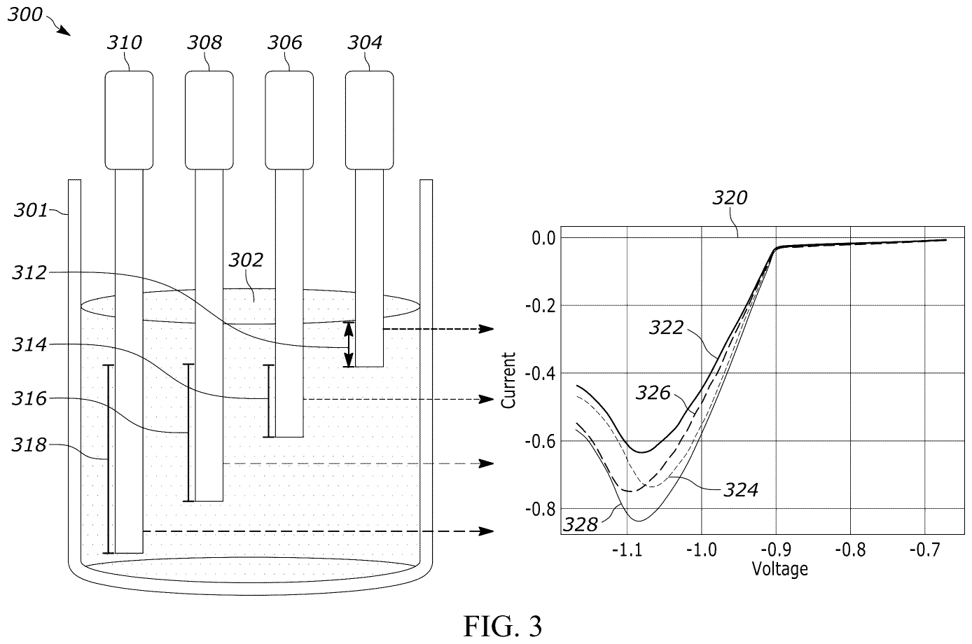

FIG. 3 depicts multiple LSV curves representing electrochemical data acquired at different depths within a fuel reprocessing tank, in accordance with various embodiments described herein. The electrochemical data acquired through the example processes illustrated in FIG. 3 may be used as inputs into the autoencoder architectures (e.g., LSTM autoencoder) described herein. However, it should be appreciated that the electrochemical data acquisition process depicted in FIG. 3 is for the purposes of discussion only, and that electrochemical data may be acquired in any suitable manner.

Namely, FIG. 3 provides a visual representation of an experimental setup 300 configured to generate a set of I-V curves 320 obtained from LSV measurements conducted in a molten salt electrolytic cell 301. These measurements may be taken, e.g., to analyze uranium concentrations within the cell 301, and the concentrations may range from approximately 0.5% to approximately 6.0% by weight. In the experimental setup 300, four electrodes 304, 306, 308, and 310 may be utilized and may have different insertion depths into the molten salt mixture 302 within the electrolytic cell 301. The first electrode 304 may be inserted at a first depth 312, the second electrode 306 may be inserted at a second depth 314 that is larger than the first depth 312, the third electrode 308 may be inserted at a third depth 316 that is larger than the second depth 314, and the fourth electrode 310 may be inserted at a fourth depth 318 that is larger than the third depth 316. Of course, it should be understood that the electrochemical data may be acquired using fewer or additional electrodes.

This experimental setup 300 may allow for a comprehensive analysis of the electrochemical reactions occurring at different depths within the electrolytic cell 301, as each electrode 304-310 may contribute to the overall dataset during measurements at different concentrations and/or sweep rates. For example, the set of I-V curves 320 depicted in FIG. 3 includes four distinct I-V curves, with each curve corresponding to a measurement from a specific electrode 304-310 at a specific uranium concentration and voltage sweep rate. The first I-V curve 322 may correspond to the measurement acquired via the first electrode 304, the second I-V curve 324 may correspond to the measurement acquired via the second electrode 306, the third I-V curve 326 may correspond to the measurement acquired via the third electrode 308, and the fourth I-V curve 328 may correspond to the measurement acquired via the fourth electrode 310. In this example, each of the I-V curves may represent measurements corresponding to a uranium concentration of approximately 6.0% within the chemical sample represented by the molten salt mixture 302.

As illustrated in the set of I-V curves 320, each curve 322-328 has a different voltage peak position and current magnitude, which may be the result of different electrochemical properties at different depths within the molten salt mixture 302. Additionally, the electrochemical data acquired using such an experimental setup 300 may be affected by the voltage sweep rate, wherein different sweep rates may change the shape of the current peaks within the curves (e.g., broader/narrower peaks). Regardless, the I-V curves 322-328 illustrated in FIG. 3 (and the electrochemical data described elsewhere herein) may represent any suitable sampling/acquisition characteristics to acquire sufficient data for input into the autoencoder architectures described herein. For example, each I-V curve 322-328 in the set of I-V curves 320 may include approximately 1000 data points, and may span voltage values from approximately −0.67 V to approximately −1.20 V.

Moreover, the electrochemical data acquired in this manner may represent “normal” or “anomalous” data sets. As mentioned, the set of I-V curves 320 generally represent a “normal” uranium concentration of approximately 6.0% within the chemical sample represented by the molten salt mixture 302. However, the electrochemical data collected using the experimental setup 300 may be part of an “anomalous” data set (e.g., for training the autoencoder) with each I-V curve corresponding to a uranium concentration of approximately 0.5% within the molten salt mixture 302. These curves may be considered anomalies due to their representation of a reduction in uranium concentration beyond what is considered a “normal” operating condition of the reprocessing system. These “anomalous” I-V curves may be used to calibrate and/or validate the autoencoder, along with “normal” I-V curves representing measurements of various “normal” uranium concentration levels (e.g., 1.0%, 2.0%, 3.0%, 4.0%, 5.0%, 6.0%).

As an example, the systems described herein may calibrate and/or otherwise optimize the autoencoder using any suitable number (e.g., 36 or more) of I-V curves spanning various portions of the “anomalous” and “normal” ranges of uranium concentrations. The systems described herein may utilize eight LSV measurements, evenly split between the “anomalous” data sets and randomly selected measurements from the “normal” data sets to evaluate the autoencoder's ability to distinguish between normal and anomalous electrochemical behavior based on the input electrochemical data (e.g., I-V curves). In certain embodiments, the systems described herein may perform hyperparameter tuning for the autoencoder using the anomalous data.

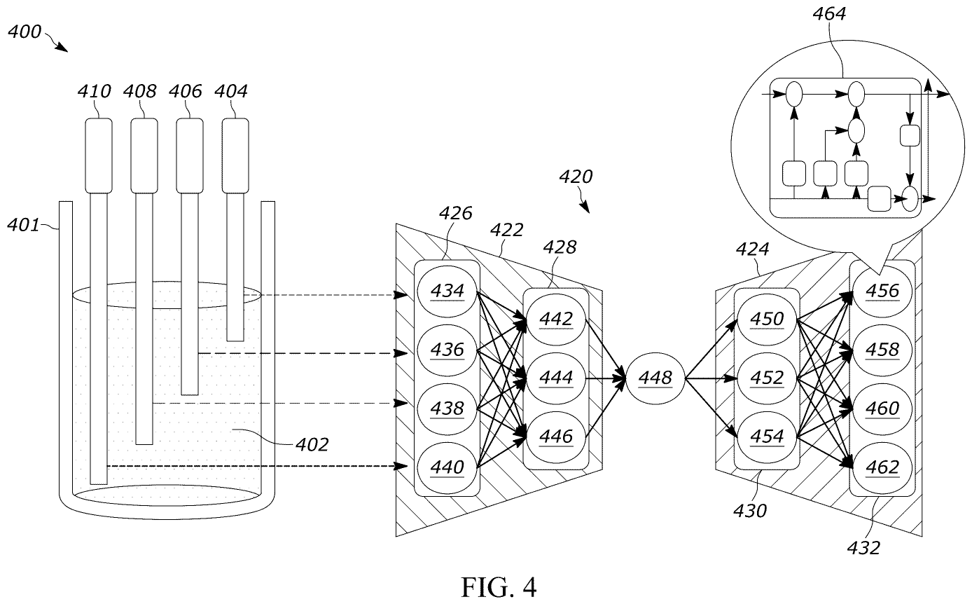

FIG. 4 depicts electrochemical data from multiple electrodes being input into an LSTM autoencoder configured to determine whether the data includes an anomaly, in accordance with various embodiments described herein. More specifically, FIG. 4 illustrates the process of acquiring electrochemical data (e.g., LSV data) from an experimental setup 400 and processing the electrochemical data using an LSTM autoencoder 420. The LSTM autoencoder 420 may be designed with four stacked layers 426, 428, 430, and 432 between the encoder 422 and the decoder 424. FIG. 4 also provides a general schematic representation of how the LSTM autoencoder 420 functions, focusing on the interrelationships between the encoder 422 and decoder 424, as well as between/among the stacked layers 426, 428, 430, and 432 and individual layers 434, 436, 438, 440, 442, 444, 446, 448, 450, 452, 454, 456, 458, 460, and 462 of the LSTM autoencoder 420.

Similar to the experimental setup 300 illustrated in FIG. 3, the experimental setup 400 depicted in FIG. 4 may include four electrodes 404, 406, 408, and 410 partially submerged in a molten salt mixture 402 within a molten salt electrolytic cell 301. Each of the electrodes 404-410 may measure electrochemical values as part of an LSV process to generate electrochemical data related to the molten salt mixture 402 that is input into the LSTM autoencoder 420. The LSTM autoencoder 420 may receive this electrochemical data input in the form of four I-V curves, corresponding to electrochemical data collected at a specific concentration and sweep rate by the various electrodes 404-410, and which may serve as the initial data set for analysis.

Generally, the LSTM autoencoder 420 includes layers 434-462 and neurons (e.g., example neuron 464) within those layers that perform the processes described herein. A layer in an LSTM autoencoder may refer to a collection of neurons that operate together at a specific level within the network. In other words, each layer 434-462 of the encoder 422 and decoder 424 may comprise one or more neurons. Each layer may be responsible for a different aspect of the learning process, with the LSTM architecture allowing for the processing of sequences of data, retaining information from inputs that have come at earlier times in the sequence. Such retention may be relevant for tasks such as time series prediction (e.g., electrochemical data anomaly detection/prediction), natural language processing, and others. A neuron within an LSTM layer may represent a single processing unit within that layer. These neurons may be responsible for receiving input from either the data or the previous layer, performing computations on this input, and then passing the result forward to a subsequent layer or as an output of the autoencoder. In the context of an LSTM layer, an individual neuron may contribute to the layer's ability to remember patterns over time by participating in the gates that control the flow of information. For example, these gates may include the input gate, the forget gate, and the output gate, which may collectively allow the neuron to selectively remember or forget information. This capability generally makes LSTM networks particularly well-suited for tasks involving sequential data (e.g., electrochemical data).

As an example, upon receiving the electrochemical data input, the data is processed through the encoder 422, which consists of four distinct layers 434, 436, 438, and 440 in the first stacked encoder layer 426 and three distinct layers 442, 444, and 446 in the second stacked encoder layer 428. Each layer 434-446 in the encoder 422 may generally be tasked with transforming the input data into a more compact representation to thereby identify and preserve relevant features of the input data. When initially input into the encoder 422, each set of electrochemical data (e.g., from each of the electrodes 404-410) may have a relatively large number of data points, and each layer 434-440 in the first stacked encoder layer 426 may be configured to handle this relatively high-dimensional data efficiently. When passed to the second stacked encoder layer 428, each output of the layers 434-440 may have substantially fewer data points, and thereby a relatively lower dimensionality than the initial inputs. Each layer 442-446 of the second stacked encoder layer 428 may be configured to efficiently handle such lower dimensionality data, such that the three layers 442-446 may receive inputs from up to each of the layers 434-440 in the first stacked encoder layer 426.

Similarly, the layers 442-446 of the second stacked encoder layer 428 may compress these inputs still further and transmit them as inputs to the bottleneck layer 448 (also referenced herein as the “latent space” representation of the encoder 422 output), which preserves relevant features from the compressed inputs from the second stacked encoder layer 428 before inputting this data into the first stacked decoder layer 430. Generally, the bottleneck layer 448 may act as a bridge between the encoder 422 and the decoder 424 within the LSTM autoencoder 420 architecture. After processing and compressing the input data through the encoder's 422 layers 434-446, the bottleneck layer 448 may capture and hold many of the most relevant features of the input data in its most compressed form. The bottleneck layer 448 may then pass this compressed data to the decoder 424, where the decoder 424 uses this information to reconstruct the original input data as closely as possible.

Similar to the encoder 422, the decoder 424 may include three distinct layers 450, 452, and 454 in a first stacked decoder layer 430 and four distinct layers 456, 458, 460, and 462 in a second stacked decoder layer 432. As mentioned, the decoder's 424 role is generally to reconstruct the data (e.g., electrochemical data) from its encoded form back to a representation that closely matches the original input, such that each layer 450-462 in the decoder 424 may be tasked with transforming the input data into a higher dimensional representation while preserving relevant features of the input data. Upon receiving the compressed data from the bottleneck layer 448 the decoder 424 is generally presented with a representation of the data that has significantly fewer data points and a much lower dimensionality than the original electrochemical data measured by the electrodes 404-410. This compressed form may be efficiently managed by the individual layers 450-454 of the first stacked decoder layer 430, which are configured to analyze such reduced dimensionality data. The first stacked decoder layer 430 may output higher dimensionality data into the second stacked decoder layer 432, where the individual layers 456-462 decompress the inputs into outputs of a similar/same dimensionality as the original inputs received from the electrodes 404-410. More specifically, the output of the decoder 424 may be a reconstructed version of the initial I-V curves, which the LSTM autoencoder 420 and/or other components described herein (e.g., anomaly detection application 116) may utilize to evaluate the LSTM autoencoder's 420 performance and/or whether the input data contains an anomaly.

It should be appreciated that the architecture of the LSTM autoencoder 420 of FIG. 4 is for the purposes of discussion only, and that the LSTM autoencoder 420 may have any suitable number of stacked layers, individual layers within the stacked layers, and/or neurons in any individual layer.

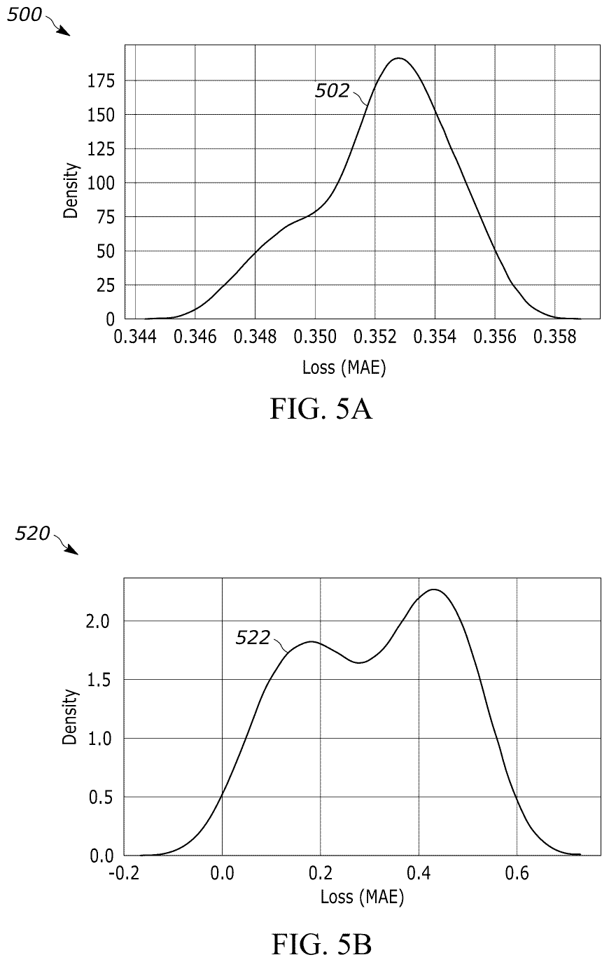

The techniques described herein may leverage this autoencoder architecture to efficiently/accurately detect anomalies within electrochemical data by also determining anomaly detection thresholds based on loss density distributions for the various voltages represented on the measured LSV curves. FIG. 5A depicts a first example loss density distribution curve 500 at a first voltage value, in accordance with various embodiments described herein. FIG. 5B depicts a second example loss density distribution curve 520 at a second voltage value, in accordance with various embodiments described herein.

The first loss density distribution curve 500 may generally represent the kernel density estimate (KDE) of the loss at the first voltage value, e.g., −1.2 V, and may demonstrate at least a portion of the values utilized by the techniques described herein when deriving an anomaly detection threshold for anomaly detection in the context of analyzing electrochemical data (e.g., current peaks as a function of applied voltage). The second loss density distribution curve 520 may generally represent the KDE of the loss at the second voltage value, e.g., −1.0675 V, and may demonstrate at least a portion of the values utilized by the techniques described herein when deriving an anomaly detection threshold for anomaly detection in the context of analyzing electrochemical data. In both cases, the x-axis may correspond to the loss values, while the y-axis may represent the density of these values, indicating the most common loss magnitudes encountered during a pseudo-testing phase of the autoencoder.

More specifically, the loss density distribution curves 500 and 520 may represent an estimation performed by one or more components described herein (e.g., anomaly detection application 116) indicating the probability density function of the loss values (e.g., MAE values) 502 and 522 recorded at −1.2 V and −1.0675 V, respectively, across multiple iterations of pseudo-testing the autoencoder. Thus, each point on the curves 500 and 520 may represent the density of loss values, providing insight into the distribution of losses at these specific voltage values.

Pseudo-testing the autoencoder may generally comprise utilizing individual sets of testing data as “pseudo-testing data” to systematically derive the loss threshold value for each point represented on an LSV curve. Namely, because the electrochemical data may have the form of current peaks as a function of applied voltage and may have approximately 1000 points comprising each LSV curve, the systems described herein may derive/determine a loss threshold value for each of 1000 points on the LSV curve. The systems described herein may determine threshold through pseudo-testing by selecting one set of I-V curves from the available sets of I-V curves (e.g., any suitable number, such as 10, 36, 102, etc.) used for the autoencoder training to serve as the pseudo-testing data. The remaining sets of curves may be used as training data, and the loss for the pseudo-testing may be recorded and stored in memory (e.g., memory 114). The systems described herein may repeat this pseudo-testing procedure for up to as many iterations as there is available pseudo-testing data sets, each time with a new pseudo-testing to obtain the loss density distribution, or KDE, as illustrated by FIGS. 5A and 5B.

Accordingly, the systems described herein may generate similar curves for each voltage value represented by a data point on the curves (e.g., LSV curves) comprising the electrochemical data. For example, the systems described herein may generate similar curves for voltage values including −0.935 V, −0.8025 V, and/or any other suitable values or combinations thereof. The systems described herein may also determine the standard deviation for the KDE at each LSV point and may then establish/determine the anomaly detection threshold based on any suitable number of standard deviations from the KDE. As mentioned, this anomaly detection threshold enables, in part, the anomaly identification techniques described herein, as it may delineate the boundary beyond which a data point's loss is considered anomalously high (e.g., suggesting a deviation from expected/normal I-V behavior).

In certain embodiments, the systems described herein may determine the anomaly detection threshold to be approximately equal to six standard deviations relative to the KDE and/or any statistical value (e.g., mean) corresponding to the KDE of any voltage value. In this manner, the anomaly detection threshold may effectively capture outliers while minimizing false positives in anomaly detection.

In some embodiments, the systems described herein may also determine the anomaly detection threshold via hyperparameter tuning during the training of the autoencoder. This process may generally involve a process of experimentation and optimization to identify the best set of parameters that allow the autoencoder to most effectively distinguish between normal and anomalous data. Namely, during the training phase, the systems described herein may adjust various parameters of the LSTM autoencoder, such as the number of layers, the number of neurons in each layer, the learning rate, and/or others, to find the configuration that yields the best performance in terms of anomaly detection accuracy. This process can be performed in any suitable manner, such as through Bayesian optimization techniques. In any event, once the model is trained with the optimal set of hyperparameters, the systems described herein may establish the anomaly detection threshold based on the distribution of reconstruction errors on a validation data set. This approach may allow for a tailored anomaly detection mechanism that is specifically optimized for the characteristics of the data being analyzed.

In some embodiments, the systems described herein may supplement the training data sets and/or pseudo-training data sets using generative techniques. For example, the systems described herein may generate additional electrochemical data for inclusion as part of (i) the set of non-anomalous electrochemical data or (ii) a set of anomalous electrochemical data using a generative adversarial network (GAN) and/or other suitable generative ML models. Moreover, during the training and/or pseudo-training of the autoencoder, the systems described herein may automatically update a weight for at least one LSTM neuron of the autoencoder based on a determination whether any set of electrochemical data includes an anomaly.

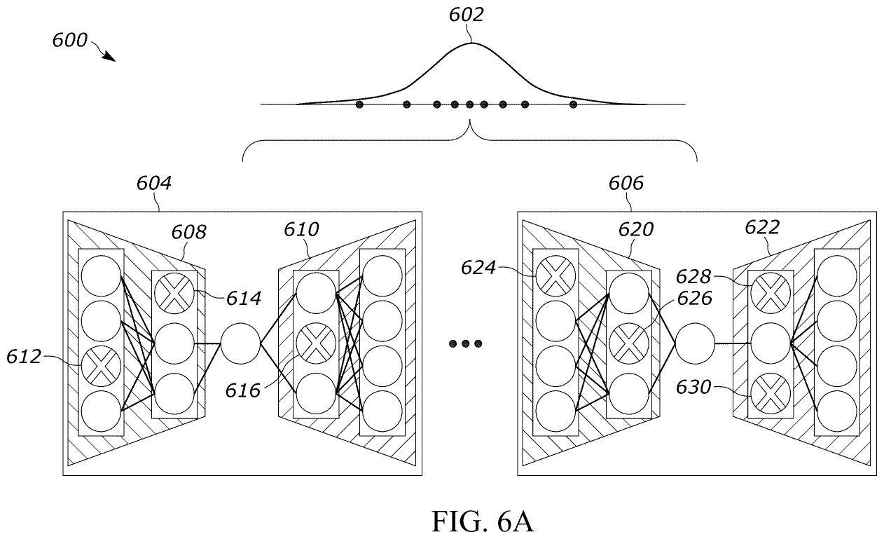

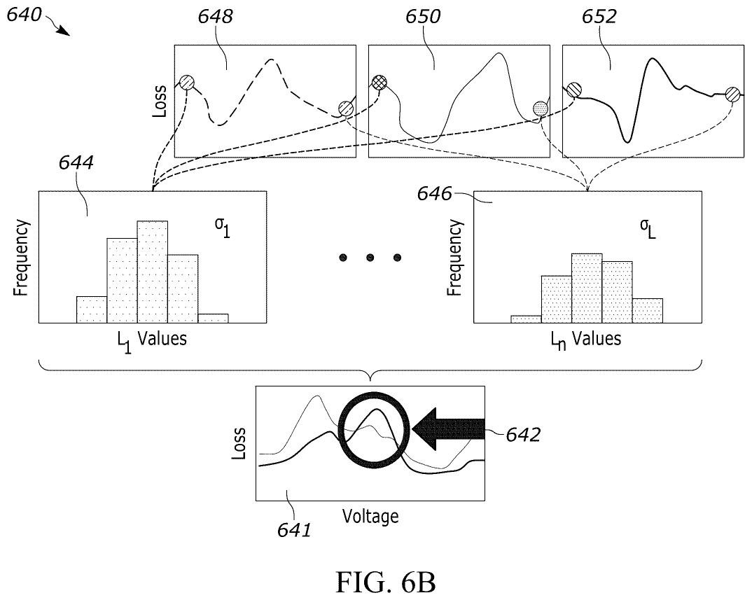

However, even after training, the LSTM autoencoder may still experience erroneous predictions, such that quantifying the model's uncertainty may be beneficial. FIG. 6A depicts an example uncertainty quantification technique 600 utilizing MC dropout to obtain a distribution 602 of autoencoder networks, in accordance with various embodiments described herein. In particular, the example uncertainty quantification techniques 600 visually represents how the MC dropout procedure generates multiple prediction samples from the original testing data by employing different, randomized versions of the autoencoder network. Each of these prediction samples is depicted as a unique instance of the network configuration after dropout, such as the first configuration 604 and the second configuration 606, contributing to the formation of an approximate parametric posterior distribution 602.

In artificial neural network (ANN) training, a dropout procedure is typically used to regulate overfitting by temporarily shutting off a certain number of nodes in a layer by stopping any input or output from these nodes for that iteration of the network training. Effectively, the dropout may create and train new daughter networks from the parent network in each iteration. The number of neurons being dropped in each layer may be random, depending on the dropout probability applied by the systems described herein (e.g., anomaly detection application 116).

For example, each configuration 604 and 606 represents the autoencoders described herein featuring a random selection of nodes/layers that are temporarily disabled during each iteration of network/model training. The first configuration 604 includes the autoencoder having an encoder 608 with a first layer 612 and a second layer 614 disabled and a decoder 610 with a first layer 616 disabled. The second configuration 606 includes the autoencoder having an encoder 620 with a first layer 624 and a second layer 626 disabled and a decoder 622 with a first layer 628 and a second layer 630 disabled.

As such, the MC dropout procedure may be used to evaluate the variations in the model predictions. This can be formulated as Bayesian inference, so that the systems described herein may assign confidence interval metrics to the predictions. In this manner, the systems described herein may determine/obtain a predictive distribution p(y|x, D), where y are the target values, x are the input variables, and D is the set of training data consisting of N samples:

D={(yᵢ,xᵢ)}ᵢ₌₁^{N} (2)

For example, D may be composed of 100 different inferences at each time step that form the basis of the Bayesian inference. For uncertainty quantification, the systems described herein may use Bayesian inference to learn the distribution of the parameters, which may be represented by the parametric posterior distribution p(Θ, D), where Θ is the configuration of the network with dropout.

In MC dropout of the LSTM autoencoder, the systems described herein may utilize dropout on network inferences to build a domain of multiple prediction samples from the original testing data, each with a different, randomized version of the same network. This is illustrated in the example uncertainty quantification technique 600 of Error! Reference source not found.6A, where the inference result from each individual dropout configuration (e.g., 604 and 606) may be a sample in the approximate parametric posterior distribution 602, given by:

Θₜ~q(Θ|D) (3),

where Θₜ is a particular instance of the network after dropout.

Sampling from the approximate posterior distribution 602 according to Bayes theorem allows the systems described herein to estimate the likelihood integral according to MC methods, which gives the predictive distribution:

$$p ( y \vert x ) \approx {\int }_{Ω} p ( y \vert x , Θ ) q ( Θ , D ) d Θ \approx \frac{1}{T} {\sum }^{T} p ( y \vert x , {Θ}_{t} ) , \qquad ( 4 )$$

where Ω may represent the sample space, and T may be the total number of samples (e.g., 100 in this case). If the likelihood integral in equation (4) is assumed to be distributed as a Gaussian, then the predictive distribution may be:

p(y|x,Θ)= [symbol] (μ_{MC},σ²_{MC}) (5)

The systems described herein may determine the mean μ_{MC} and variance ρ²_{MC} directly by evaluations of the different MC dropout inferences. In turn, the systems described herein may utilize these moments to determine a 95% confidence interval, which may be the uncertainty quantification metric of the autoencoder.

It should be appreciated that the MC dropout procedure described herein may perform any suitable number of permutations/combinations of randomized node/layer dropout within the autoencoder architecture (e.g., any number of configurations, similar to 604 and 606) to achieve the approximate posterior distribution 602 and/or to achieve any other suitable purpose or combinations thereof. Further, the dropout referenced herein may refer to dropout of individual layers, neurons within each layer, and/or any combination thereof.

FIG. 6B depicts another example uncertainty quantification technique 640, in accordance with various embodiments described herein. In particular, FIG. 6B depicts how an LSTM autoencoder (e.g., autoencoder 118) may leverage statistical characteristics of loss distributions from electrochemical data (e.g., LSV data) at different voltage steps to refine anomaly detection. The example uncertainty quantification technique 640 includes a first voltage-loss graph 641 having a detected anomaly 642 where the loss values at one or more voltage steps/values exceeds the corresponding loss threshold value(s) at those voltage steps/values.

This first voltage-loss graph 641 may more generally represent the loss values across each voltage step of data acquired during an LSV testing process. Each step of the voltage range may also have its own loss density distribution, as represented by the individual voltage loss density distribution graphs 644 through 646, where there may be a similar loss density distribution graph for each voltage applied during the LSV testing process. The systems described herein may utilize the values represented by the voltage loss density distribution graphs 644 through 646 to generate/determine an individual anomaly detection threshold value (e.g., a variable threshold) for each individual voltage step. Accordingly, the systems described herein may determine the variable anomaly detection thresholds 648, 650, and 652 that may be used to evaluate test loss values at various voltage steps (e.g., as in the first voltage-loss graph 641) to determine whether an anomaly (e.g., 642) is present. Thus, the example uncertainty quantification technique 640 indicates how using dynamic thresholds tailored to specific voltage steps may improve anomaly detection accuracy in electrochemical systems.

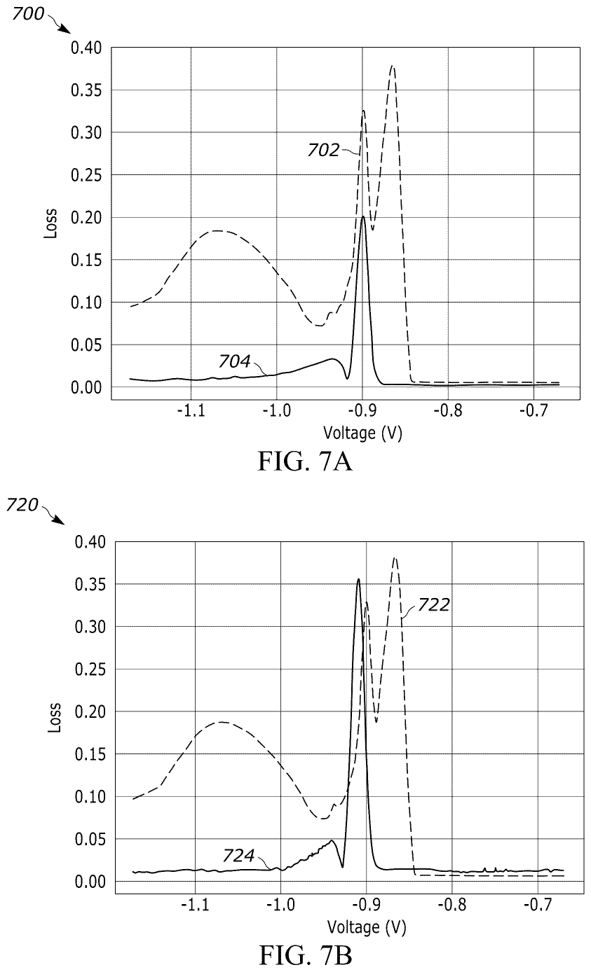

FIG. 7A is a first graph 700 illustrating a first example comparison of a test loss corresponding to normal data to an anomaly detection threshold curve 702, in accordance with various embodiments described herein. The first graph 700 includes an x-axis that may represent the progression of the LSV testing through various voltages, and the y-axis may represent the test loss at that voltage. The first graph 700 thus generally represents how the test loss varies across the voltage range while staying below the anomaly detection threshold.

In particular, the first graph 700 illustrates the results of testing an LSTM autoencoder model on “normal” data, specifically showcasing the true negative results where every point on the normal data test loss curve 704 is below the anomaly detection threshold curve 702. The first graph 700 may generally represent the expected relationship between normal data at any concentration value for the chemical(s) of interest in a chemical sample, e.g., a 6.0% concentration of uranium in a molten salt mixture during spent nuclear fuel reprocessing (e.g., performed by the reprocessing system 104). This behavior may thereby indicate that the autoencoder effectively identifies the data as “normal” without falsely categorizing it as an anomaly, hence being categorized as a true negative result.

In contrast, FIG. 7B is a second graph 720 illustrating a second example comparison of a test loss corresponding to anomalous data to the anomaly detection threshold curve 722, in accordance with various embodiments described herein. Similar to the first graph 700, the second graph 720 includes an x-axis that may represent the progression of the LSV testing through various voltages, and the y-axis may represent the test loss at that voltage. The second graph 720 generally represents how the test loss varies across the voltage range, and how loss values for anomalous data may cross the anomaly detection threshold at one or more points, indicating the anomaly.

In particular, the second graph 720 illustrates the results of testing an LSTM autoencoder model on “anomalous” data, specifically showcasing the true positive results where a portion of the anomalous data test loss curve 724 is above the anomaly detection threshold curve 722. The second graph 720 may generally represent the expected relationship between anomalous data at a relatively low concentration value for the chemical(s) of interest in a chemical sample, e.g., a 0.5% concentration of uranium in a molten salt mixture during spent nuclear fuel reprocessing (e.g., performed by the reprocessing system 104). For example, the anomalous data test loss curve 724 signal may surpass the anomaly detection threshold curve 722 with a peak centered at approximately −0.95 V. This behavior may thereby indicate that the autoencoder effectively identifies the data as “anomalous,” hence being categorized as a true positive result.

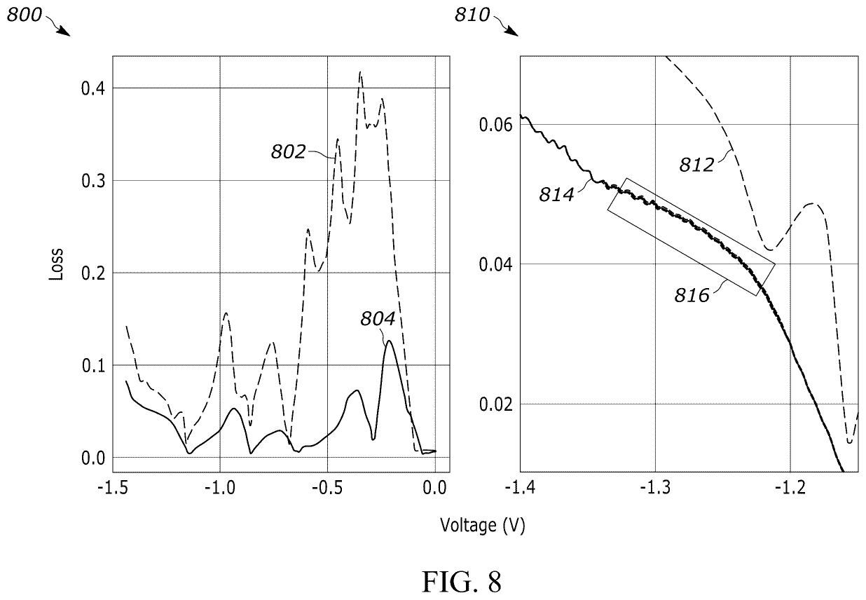

FIG. 8 includes two graphs 800 and 810 depicting an example test loss compared to an anomaly detection threshold across an entire voltage range and across an interval of the entire voltage range, in accordance with various embodiments described herein. In particular, when MC dropout is utilized to train the autoencoder, the two graphs 800 and 810 may illustrate the 95% confidence intervals for the uncertainty quantification in the autoencoder.

The first graph 800 of FIG. 8 may depict the entire voltage range (e.g., between approximately −1.5 V to 0 V), showcasing the application of MC dropout-based uncertainty quantification across this range. The first graph 800 may include an anomaly detection threshold curve 802 and a test loss curve 804 that may also include the 95% confidence intervals surrounding the curve 804. These confidence intervals are more visible as the thicker regions of the curve 814 in the second graph 810.

The first graph 800 and second graph 810 may represent scenarios where up to each layer in the autoencoder may include dropout layers with a dropout rate of approximately 10%. This dropout may introduce variance into the predictive distribution without significantly impacting the model's prediction and anomaly detection capabilities. Accordingly, the systems described herein may iteratively train the model for any suitable number of epochs (e.g., 10, 50, 100, etc.), and the predictions may be repeated any suitable number of times post-training (e.g., 10, 50, 100, etc.) to construct the distribution from which the systems described herein may derive the mean μ_{MC} and the variance. σ²_{MC}, as discussed herein. The variance may be expressed as a percentage of the error for an individual electrode that the systems described herein may average to obtain a final average loss value and resulting uncertainty bounds. These bounds may narrow across the voltage range, indicating a high degree of confidence in the model's predictions.

The second graph 810 may provide a more focused view of a specific interval within the voltage range where uncertainty may be notably higher than in other regions of the voltage range. The second graph 810 may include a portion of the anomaly detection threshold curve 812 and a portion of the test loss curve 814. This focused view may highlight a region 816 of the portion of the test loss curve 814 with a 95% confidence band, indicated as a slightly thicker region of the curve 814, where the uncertainty bounds are wider than in other regions of the curve 814. This increased uncertainty may generally be observed at the peaks of the loss curve and in regions where the loss slope undergoes changes, suggesting areas of lower confidence in the model's predictions.

In certain embodiments, the systems described herein may translate these uncertainty bounds, e.g., as depicted in the region 816, into an estimate of certainty by determining the percentage of points along the voltage that fall within the uncertainty bounds between the test loss and a predefined threshold. A lower percentage may indicate higher certainty in the autoencoder's results, enhancing the model's trustworthiness. For example, using the techniques described herein, the maximum uncertainty may be approximately 1.09% at a threshold of three standard deviations, decreasing as the threshold is raised. This certainty threshold may stabilize at approximately fifteen standard deviations, maintaining approximately 0.30% uncertainty even with higher thresholds, underscoring the effectiveness of MC dropout-based uncertainty quantification in identifying areas of high and low certainty within the model's predictions, and consequently providing insights into the model's performance and reliability in anomaly detection and prediction tasks.

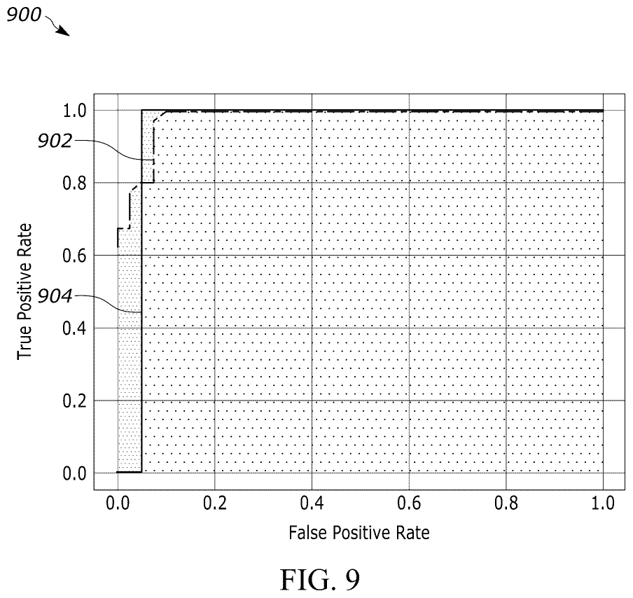

FIG. 9 is a graph 900 illustrating the false positive rates and the true positive rates associated with anomaly detection performed using an LSTM autoencoder and principal component analysis (PCA), in accordance with various embodiments described herein. This graph 900 may provide an illustrative representation of a Receiver Operating Curve (ROC) metric, which may depict the diagnostic ability of a binary classifier system as its discrimination threshold is varied.

The two ROC curves 902 and 904 illustrated in FIG. 9 may plot two parameters: the True Positive Rate (TPR) on the y-axis and the False Positive Rate (FPR) on the x-axis. The ROC curves 902 and 904 thus showcase the trade-off between sensitivity (TPR) and specificity (FPR). Each curve 902 and 904 may begin at the bottom left corner of the graph 900, representing a situation where the autoencoder correctly identifies all negative cases (e.g., zero false positives) but also misses all positive cases (e.g., zero true positives). As the curves 902 and 904 progress toward the upper right corner, it indicates an increase in the autoencoder's ability to correctly identify positive cases, with the trade-off of incorrectly classifying some negative cases as positive. Therefore, an ideally trained autoencoder would generate a curve that reaches the top-left corner of the graph 900, such that all true positives are correctly identified without any false positive classifications.

To quantify the overall performance of a classifier as depicted in the ROC curves 902 and 904, the systems described herein may determine the Area Under the Curve (AUC) for each curve 902 and 904. The AUC provides a single scalar value that summarizes the entire ROC curve. It may range from 0 to 1, where an AUC of 1 indicates a perfect classifier, and an AUC of 0.5 suggests a classifier that performs no better than random chance.

The respective ROC curves 902 and 904 in FIG. 9 represent the ROC values associated with two different classifiers: an LSTM autoencoder (902) and a PCA based classifier (904). The systems described herein may evaluate both classifiers based on their ROC curves 902 and 904 and corresponding AUC values. Such comparison may indicate that while both classifiers perform well, the LSTM autoencoder exhibits a superior AUC value, outperforming the PCA-based classifier by approximately 3%. This may indicate that the LSTM autoencoder has a better overall classification performance across a range of thresholds. These results may further suggest that the performance gap between the PCA-based classifier and the LSTM autoencoder may widen as the complexity of the data increases. In other words, as the available data used to train LSTM autoencoders increases in size, the nonlinearities and increased variance typical of such scenarios may enable the LSTM autoencoder to achieve even greater efficiencies and corresponding accuracy relative to other classifiers.

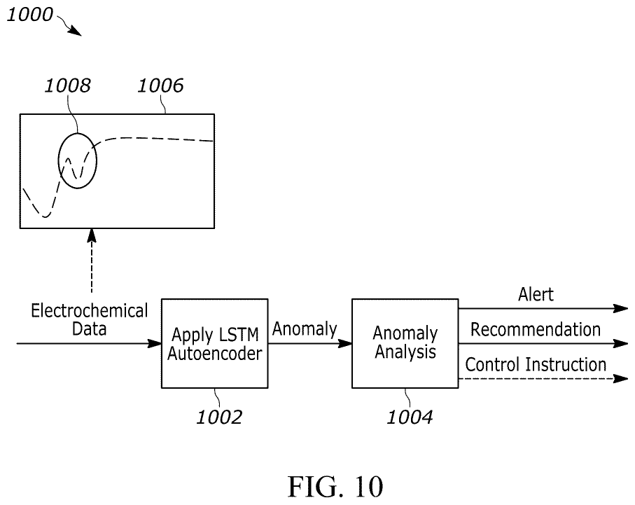

FIG. 10 depicts an example workflow 1000 for generating alerts, recommendations, and/or control instructions in response to determining that electrochemical data includes an anomaly, in accordance with various embodiments described herein. The example workflow 1000 may generally be performed by any suitable components or systems described herein (e.g., anomaly detection system 102).

The example workflow 1000 may include receiving electrochemical data at a first block 1002 where an LSTM autoencoder is applied to the electrochemical data to output an indication of an anomaly. The electrochemical data may generally be represented by the example electrochemical data 1006 that includes an anomaly 1008. When the LSTM autoencoder identifies the anomaly 1008 within the electrochemical data 1006, the systems described herein may analyze the anomaly to determine how to address the anomaly (block 1004). For example, the systems described herein may analyze the anomaly and determine that a user/operator should be alerted to the presence of the anomaly and may thereafter generate an alert indicating the anomaly. This alert may include information about the anomaly, including the anomaly's presence within the electrochemical data 1006, a description of the anomaly (e.g., low concentration of chemical within sample), a timestamp associated with when the data was measured, and/or any other suitable information associated with the anomaly and/or the corresponding electrochemical data.

In certain embodiments, the alert may be or include a recommendation to the user/operator that indicates a recommended action to be taken that is likely to resolve the anomaly. For example, the systems described herein may detect an anomaly within electrochemical data representing uranium concentrations within a molten salt sample during spent nuclear fuel reprocessing. If the systems detect uranium concentrations that are significantly lower than expected, indicating a potential issue in the extraction process, the recommendation might be to adjust the chemical reagent feed rate to correct the concentration levels. This action could involve increasing the feed rate of a specific reagent known to facilitate the extraction of uranium, thereby ensuring that the concentration levels within the molten salt return to within acceptable parameters.

In some embodiments, the alert may be or include (i) a recommendation related to resolving the anomaly, (ii) a cause of the anomaly, (iii) an indication of a chemical element included as part of the chemical sample that is outside of a predetermined range, and/or (iv) a graphical rendering of a system from which the electrochemical data is received. The alerts/recommendations may be displayed on a user interface (e.g., workstation 130), highlighting the detected anomaly in the electrochemical data and providing a concise recommendation for the corrective action. Such display may include step-by-step instructions or a direct command option to adjust the reagent feed rate automatically, e.g., via a control instruction issued directly to the components (e.g., components 128) responsible for adjusting the reagent feed rate.

Additionally, the alert may offer an option to review more detailed information about the anomaly and the rationale behind the recommended action, enabling the user/operator to make an informed decision on how to proceed. For example, the alert may include and/or graphically indicate the components (e.g., components 128) responsible for the anomaly, and may further graphically indicate one or more components that the user/operator may adjust to resolve the anomaly. This approach may ensure that the user/operator is promptly informed of both the issue and the suggested resolution, facilitating quick and effective intervention to maintain the integrity of the spent nuclear fuel reprocessing operation.

### Example Computer-Implemented Methods

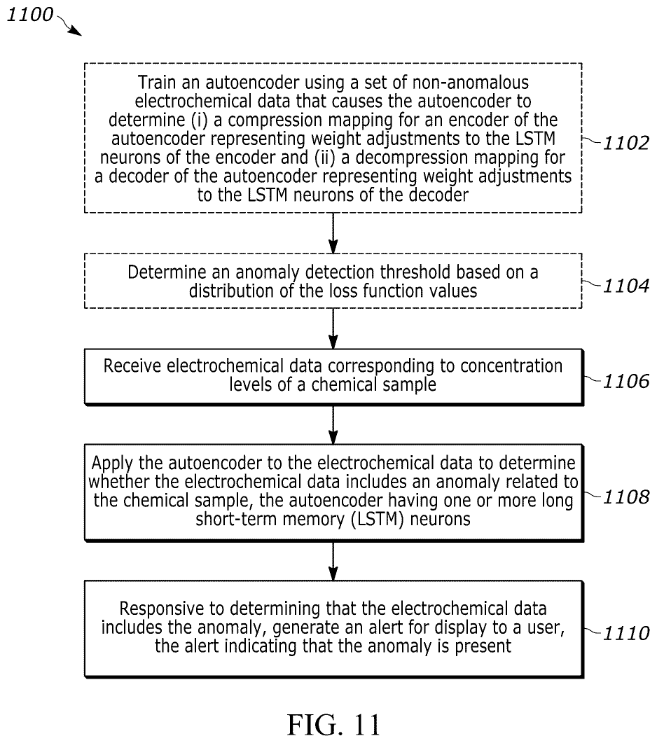

FIG. 11 depicts a flow diagram representing an example computer-implemented method 1100, in accordance with various embodiments described herein. The method 1100 may be implemented by one or more processors of the example computing system 100, such as the processor 108 of the anomaly detection system 102 (e.g., by anomaly detection application 116), for example.

The method 1100 may optionally include training an autoencoder using a set of non-anomalous electrochemical data that causes the autoencoder to determine (i) a compression mapping for an encoder of the autoencoder representing weight adjustments to the LSTM neurons of the encoder and (ii) a decompression mapping for a decoder of the autoencoder representing weight adjustments to the LSTM neurons of the decoder (block 1102). Each weight adjustment to the LSTM neurons may correspond to a loss function value from comparing a data point input into the encoder to an output data point from the decoder. The method 1100 may further include determining an anomaly detection threshold based on a distribution of the loss function values (block 1104).

The method 1110 may further include receiving electrochemical data corresponding to concentration levels of a chemical sample (block 1106). The method 1100 may further include applying an autoencoder to the electrochemical data to determine whether the electrochemical data includes an anomaly related to the chemical sample (block 1108). The autoencoder may have one or more LSTM neurons. The method 1100 may further comprise, responsive to determining that the electrochemical data includes the anomaly, generating an alert for display to a user (block 1110). The alert may indicate that the anomaly is present.

In certain embodiments, the electrochemical data may include a plurality of datasets acquired using a plurality of sensing components, and applying the autoencoder to the electrochemical data may further include compressing, between input layers of the LSTM neurons by an encoder of the autoencoder, the plurality of datasets into a reduced dimension dataset by removing portions of the plurality of datasets that are unrelated to temporal characteristics of the plurality of datasets; decompressing, between output layers of the LSTM neurons by a decoder of the autoencoder, the reduced dimension dataset by incorporating predicted data points to generate a decompressed plurality of datasets; and determining a loss function value for data points included as part of the plurality of datasets by comparing the data points of the plurality of datasets to analogous points in the decompressed plurality of datasets.

In certain embodiments, the loss function value may be at least one of: (i) an MAE value, (ii) an MSE value, (iii) a binary cross-entropy loss value, (iv) an MSLE value, (v) a categorical cross-entropy loss value, (vi) a Huber loss value, (vii) a cosine similarity loss value, and/or (viii) a KL divergence value.

In certain embodiments, the method 1100 may further include iteratively adjusting the anomaly detection threshold as a hyperparameter of the autoencoder, and wherein the anomaly detection threshold is set to a value corresponding to a plurality of standard deviations away from a mean loss function value.

In certain embodiments, the method 1100 may further include generating additional electrochemical data for inclusion as part of (i) the set of non-anomalous electrochemical data or (ii) a set of anomalous electrochemical data using a GAN.

In certain embodiments, the autoencoder may include one or more dropout layers between LSTM neuron layers, and at least one dropout layer has a dropout rate between 5% to 20%.

In certain embodiments, the electrochemical data is a first set of electrochemical data, and the method 1100 may further include training the autoencoder for a plurality of epochs; iteratively applying the autoencoder to a second set of electrochemical data to determine a predictive distribution of the autoencoder, wherein each iterative application of the autoencoder utilizes a different subset of LSTM neurons; determining a final loss value based on a mean and a variance of the predictive distribution; and determining an anomaly detection threshold based on the final loss value, wherein the system determines whether the first set of electrochemical data includes the anomaly based on the anomaly detection threshold.

In certain embodiments, the iterative application of the autoencoder is performed as part of an MC dropout uncertainty quantification process.

In certain embodiments, the method 1100 may further include automatically updating a weight for at least one LSTM neuron of the autoencoder based on the determination whether the electrochemical data includes the anomaly.

In certain embodiments, the electrochemical data may be associated with LSV measurements, the chemical sample may correspond to one or more chemicals included as part of a molten salt sample, the electrochemical data may be received from a molten salt fuel reprocessing system, and/or the electrochemical data may include a plurality of datasets acquired using a plurality of dendrites submerged in molten salt at a plurality of depths.

In certain embodiments, the alert may further indicate at least one of: (i) a recommendation related to resolving the anomaly, (ii) a cause of the anomaly, (iii) an indication of a chemical element included as part of the chemical sample that is outside of a predetermined range, and/or (iv) a graphical rendering of a system from which the electrochemical data is received.

Of course, it is to be appreciated that the actions of the method 1100 may be performed any suitable number of times, and that the actions described in reference to the method 1100 may be performed in any suitable order.

### Aspects

Aspect 1. A system for improved anomaly detection, comprising: one or more memories storing executable instructions; and one or more processors configured to execute the executable instructions to cause the system to: receive electrochemical data corresponding to concentration levels of a chemical sample, apply an autoencoder to the electrochemical data to determine whether the electrochemical data includes an anomaly related to the chemical sample, the autoencoder having one or more LSTM neurons, and responsive to determining that the electrochemical data includes the anomaly, generate an alert for display to a user, the alert indicating that the anomaly is present.

Aspect 2. The system of aspect 1, wherein the electrochemical data comprises a plurality of datasets acquired using a plurality of sensing components, and wherein applying the autoencoder to the electrochemical data further comprises: compressing, between input layers of the LSTM neurons by an encoder of the autoencoder, the plurality of datasets into a reduced dimension dataset by removing portions of the plurality of datasets that are unrelated to temporal characteristics of the plurality of datasets; decompressing, between output layers of the LSTM neurons by a decoder of the autoencoder, the reduced dimension dataset by incorporating predicted data points to generate a decompressed plurality of datasets; and determining a loss function value for data points included as part of the plurality of datasets by comparing the data points of the plurality of datasets to analogous points in the decompressed plurality of datasets.

Aspect 3. The system of aspect 2, wherein the loss function value is at least one of: (i) an MAE, (ii) an MSE, (iii) a binary cross-entropy loss, (iv) an MSLE, (v) a categorical cross-entropy loss, (vi) a Huber loss, (vii) a cosine similarity loss, or (viii) a KL divergence.

Aspect 4. The system of any of aspects 1 through 3, wherein the executable instructions, when executed, further cause the system to: train the autoencoder using a set of non-anomalous electrochemical data that causes the autoencoder to determine (i) a compression mapping for an encoder of the autoencoder representing weight adjustments to the LSTM neurons of the encoder and (ii) a decompression mapping for a decoder of the autoencoder representing weight adjustments to the LSTM neurons of the decoder, wherein each weight adjustment to the LSTM neurons corresponds to a loss function value from comparing a data point input into the encoder to an output data point from the decoder; and determine an anomaly detection threshold based on a distribution of the loss function values.

Aspect 5. The system of aspect 4, wherein the executable instructions, when executed, further cause the system to: iteratively adjust the anomaly detection threshold as a hyperparameter of the autoencoder, and wherein the anomaly detection threshold is set to a value corresponding to a plurality of standard deviations away from a mean loss function value.

Aspect 6. The system of aspect 4 or 5, wherein the executable instructions, when executed, further cause the system to: generate additional electrochemical data for inclusion as part of (i) the set of non-anomalous electrochemical data or (ii) a set of anomalous electrochemical data using a GAN.

Aspect 7. The system of any of aspects 1 through 6, wherein the autoencoder includes one or more dropout layers between LSTM neuron layers, and at least one dropout layer has a dropout rate between 5% to 20%.

Aspect 8. The system of aspect 7, wherein the electrochemical data is a first set of electrochemical data, and wherein the executable instructions, when executed, further cause the system to: train the autoencoder for a plurality of epochs; iteratively apply the autoencoder to a second set of electrochemical data to determine a predictive distribution of the autoencoder, wherein each iterative application of the autoencoder utilizes a different subset of LSTM neurons; determine a final loss value based on a mean and a variance of the predictive distribution; and determine an anomaly detection threshold based on the final loss value, wherein the system determines whether the first set of electrochemical data includes the anomaly based on the anomaly detection threshold.

Aspect 9. The system of aspect 8, wherein the iterative application of the autoencoder is performed as part of a MC dropout uncertainty quantification process.

Aspect 10. The system of any of aspects 1 through 9, wherein the executable instructions, when executed, further cause the system to: automatically update a weight for at least one LSTM neuron of the autoencoder based on the determination whether the electrochemical data includes the anomaly.

Aspect 11. The system of any of aspects 1 through 10, wherein at least one of: the electrochemical data is associated with LSV measurements; the chemical sample corresponds to one or more chemicals included as part of a molten salt sample; the electrochemical data is received from a molten salt fuel reprocessing system; or the electrochemical data comprises a plurality of datasets acquired using a plurality of dendrites submerged in molten salt at a plurality of depths.

Aspect 12. The system of any of aspects 1 through 11, wherein the alert further indicates at least one of: (i) a recommendation related to resolving the anomaly, (ii) a cause of the anomaly, (iii) an indication of a chemical element included as part of the chemical sample that is outside of a predetermined range, or (iv) a graphical rendering of a system from which the electrochemical data is received.

Aspect 13. A method for improved anomaly detection, comprising: receiving, by one or more processors, electrochemical data corresponding to concentration levels of a chemical sample; applying, by the one or more processors, an autoencoder to the electrochemical data to determine whether the electrochemical data includes an anomaly related to the chemical sample, the autoencoder having one or more LSTM neurons; and responsive to determining that the electrochemical data includes the anomaly, generating, by the one or more processors, an alert for display to a user, the alert indicating that the anomaly is present.

Aspect 14. The method of aspect 13, wherein the electrochemical data comprises a plurality of datasets acquired using a plurality of sensing components, and wherein applying the autoencoder to the electrochemical data further comprises: compressing, between input layers of the LSTM neurons by an encoder of the autoencoder, the plurality of datasets into a reduced dimension dataset by removing portions of the plurality of datasets that are unrelated to temporal characteristics of the plurality of datasets; decompressing, between output layers of the LSTM neurons by a decoder of the autoencoder, the reduced dimension dataset by incorporating predicted data points to generate a decompressed plurality of datasets; and determining, by the one or more processors, a loss function value for data points included as part of the plurality of datasets by comparing the data points of the plurality of datasets to analogous points in the decompressed plurality of datasets.

Aspect 15. The method of aspect 14, wherein the loss function value is at least one of: (i) an MAE, (ii) an MSE, (iii) a binary cross-entropy loss, (iv) an MSLE, (v) a categorical cross-entropy loss, (vi) a Huber loss, (vii) a cosine similarity loss, or (viii) a KL divergence.

Aspect 16. The method of any of aspects 13 through 15, further comprising: training, by the one or more processors, the autoencoder using a set of non-anomalous electrochemical data that causes the autoencoder to determine (i) a compression mapping for an encoder of the autoencoder representing weight adjustments to the LSTM neurons of the encoder and (ii) a decompression mapping for a decoder of the autoencoder representing weight adjustments to the LSTM neurons of the decoder, wherein each weight adjustment to the LSTM neurons corresponds to a loss function value from comparing a data point input into the encoder to an output data point from the decoder; and determining, by the one or more processors, an anomaly detection threshold based on a distribution of the loss function values.

Aspect 17. The method of aspect 16, further comprising: iteratively adjusting, by the one or more processors, the anomaly detection threshold as a hyperparameter of the autoencoder, and wherein the anomaly detection threshold is set to a value corresponding to a plurality of standard deviations away from a mean loss function value.

Aspect 18. The method of aspect 16 or 17, further comprising: generating, by the one or more processors, additional electrochemical data for inclusion as part of (i) the set of non-anomalous electrochemical data or (ii) a set of anomalous electrochemical data using a GAN.

Aspect 19. The method of any of aspects 13 through 18, wherein the autoencoder includes one or more dropout layers between LSTM neuron layers, wherein at least one dropout layer has a dropout rate between 5% to 20%, wherein the electrochemical data is a first set of electrochemical data, and wherein the method further comprises: training, by the one or more processors, the autoencoder for a plurality of epochs; iteratively applying, by the one or more processors, the autoencoder to a second set of electrochemical data to determine a predictive distribution of the autoencoder, wherein each iterative application of the autoencoder utilizes a different subset of LSTM neurons; determining, by the one or more processors, a final loss value based on a mean and a variance of the predictive distribution; and determining, by the one or more processors, an anomaly detection threshold based on the final loss value, wherein determining whether the first set of electrochemical data includes the anomaly is based on the anomaly detection threshold.

Aspect 20. A non-transitory computer-readable medium, comprising executable instructions that, when executed by one or more processors, cause the one or more processors to perform actions comprising: receiving electrochemical data corresponding to concentration levels of a chemical sample; applying an autoencoder to the electrochemical data to determine whether the electrochemical data includes an anomaly related to the chemical sample, the autoencoder having one or more LSTM neurons; and responsive to determining that the electrochemical data includes the anomaly, generating an alert for display to a user, the alert indicating that the anomaly is present.

### Additional Considerations

The following additional considerations apply to the foregoing discussion. Throughout this specification, plural instances may implement functions, components, operations, or structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Accordingly, the term hardware should be understood to encompass a tangible entity, which may be one of an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of exemplary functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or functions described herein may be at least partially processor-implemented. For example, at least some of the functions of a method may be performed by one or more processors or processor-implemented hardware modules. The performance of certain of the functions may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors). These operations are accessible via a network (e.g., the Internet) and via one or more appropriate interfaces (e.g., application program interfaces (APIs)).

The performance of certain operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or an “algorithm” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a system 100 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the techniques disclosed herein without departing from the spirit and scope defined in the appended claims.

What is claimed is:

1. A system for improved anomaly detection, comprising:
one or more memories storing executable instructions; and
one or more processors configured to execute the executable instructions to cause the system to:
receive electrochemical data corresponding to concentration levels of a chemical sample,
apply an autoencoder to the electrochemical data to determine whether the electrochemical data includes an anomaly related to the chemical sample, the autoencoder having one or more long short-term memory (LSTM) neurons, and
responsive to determining that the electrochemical data includes the anomaly, generate an alert for display to a user, the alert indicating that the anomaly is present.

2. The system of claim 1, wherein the electrochemical data comprises a plurality of datasets acquired using a plurality of sensing components, and wherein applying the autoencoder to the electrochemical data further comprises:
compressing, between input layers of the LSTM neurons by an encoder of the autoencoder, the plurality of datasets into a reduced dimension dataset by removing portions of the plurality of datasets that are unrelated to temporal characteristics of the plurality of datasets;
decompressing, between output layers of the LSTM neurons by a decoder of the autoencoder, the reduced dimension dataset by incorporating predicted data points to generate a decompressed plurality of datasets; and
determining a loss function value for data points included as part of the plurality of datasets by comparing the data points of the plurality of datasets to analogous points in the decompressed plurality of datasets.

3. The system of claim 2, wherein the loss function value is at least one of: (i) a mean absolute error (MAE), (ii) a mean squared error (MSE), (iii) a binary cross-entropy loss, (iv) a mean squared logarithmic error (MSLE), (v) a categorical cross-entropy loss, (vi) a Huber loss, (vii) a cosine similarity loss, or (viii) a Kullback-Liebler (KL) divergence.

4. The system of claim 1, wherein the executable instructions, when executed, further cause the system to:
train the autoencoder using a set of non-anomalous electrochemical data that causes the autoencoder to determine (i) a compression mapping for an encoder of the autoencoder representing weight adjustments to the LSTM neurons of the encoder and (ii) a decompression mapping for a decoder of the autoencoder representing weight adjustments to the LSTM neurons of the decoder, wherein each weight adjustment to the LSTM neurons corresponds to a loss function value from comparing a data point input into the encoder to an output data point from the decoder; and
determine an anomaly detection threshold based on a distribution of the loss function values.

5. The system of claim 4, wherein the executable instructions, when executed, further cause the system to:
iteratively adjust the anomaly detection threshold as a hyperparameter of the autoencoder, and wherein the anomaly detection threshold is set to a value corresponding to a plurality of standard deviations away from a mean loss function value.

6. The system of claim 4, wherein the executable instructions, when executed, further cause the system to:
generate additional electrochemical data for inclusion as part of (i) the set of non-anomalous electrochemical data or (ii) a set of anomalous electrochemical data using a generative adversarial network (GAN).

7. The system of claim 1, wherein the autoencoder includes one or more dropout layers between LSTM neuron layers, and at least one dropout layer has a dropout rate between 5% to 20%.

8. The system of claim 7, wherein the electrochemical data is a first set of electrochemical data, and wherein the executable instructions, when executed, further cause the system to:
train the autoencoder for a plurality of epochs;
iteratively apply the autoencoder to a second set of electrochemical data to determine a predictive distribution of the autoencoder, wherein each iterative application of the autoencoder utilizes a different subset of LSTM neurons;
determine a final loss value based on a mean and a variance of the predictive distribution; and
determine an anomaly detection threshold based on the final loss value, wherein the system determines whether the first set of electrochemical data includes the anomaly based on the anomaly detection threshold.

9. The system of claim 8, wherein the iterative application of the autoencoder is performed as part of a Monte Carlo (MC) dropout uncertainty quantification process.

10. The system of claim 1, wherein the executable instructions, when executed, further cause the system to:
automatically update a weight for at least one LSTM neuron of the autoencoder based on the determination whether the electrochemical data includes the anomaly.

11. The system of claim 1, wherein at least one of:
the electrochemical data is associated with linear sweep voltammetry (LSV) measurements;
the chemical sample corresponds to one or more chemicals included as part of a molten salt sample;
the electrochemical data is received from a molten salt fuel reprocessing system; or
the electrochemical data comprises a plurality of datasets acquired using a plurality of dendrites submerged in molten salt at a plurality of depths.

12. The system of claim 1, wherein the alert further indicates at least one of: (i) a recommendation related to resolving the anomaly, (ii) a cause of the anomaly, (iii) an indication of a chemical element included as part of the chemical sample that is outside of a predetermined range, or (iv) a graphical rendering of a system from which the electrochemical data is received.

13. A method for improved anomaly detection, comprising:
receiving, by one or more processors, electrochemical data corresponding to concentration levels of a chemical sample;
applying, by the one or more processors, an autoencoder to the electrochemical data to determine whether the electrochemical data includes an anomaly related to the chemical sample, the autoencoder having one or more long short-term memory (LSTM) neurons; and
responsive to determining that the electrochemical data includes the anomaly, generating, by the one or more processors, an alert for display to a user, the alert indicating that the anomaly is present.

14. The method of claim 13, wherein the electrochemical data comprises a plurality of datasets acquired using a plurality of sensing components, and wherein applying the autoencoder to the electrochemical data further comprises:
compressing, between input layers of the LSTM neurons by an encoder of the autoencoder, the plurality of datasets into a reduced dimension dataset by removing portions of the plurality of datasets that are unrelated to temporal characteristics of the plurality of datasets;
decompressing, between output layers of the LSTM neurons by a decoder of the autoencoder, the reduced dimension dataset by incorporating predicted data points to generate a decompressed plurality of datasets; and
determining, by the one or more processors, a loss function value for data points included as part of the plurality of datasets by comparing the data points of the plurality of datasets to analogous points in the decompressed plurality of datasets.

15. The method of claim 14, wherein the loss function value is at least one of: (i) a mean absolute error (MAE), (ii) a mean squared error (MSE), (iii) a binary cross-entropy loss, (iv) a mean squared logarithmic error (MSLE), (v) a categorical cross-entropy loss, (vi) a Huber loss, (vii) a cosine similarity loss, or (viii) a Kullback-Liebler (KL) divergence.

16. The method of claim 13, further comprising:
training, by the one or more processors, the autoencoder using a set of non-anomalous electrochemical data that causes the autoencoder to determine (i) a compression mapping for an encoder of the autoencoder representing weight adjustments to the LSTM neurons of the encoder and (ii) a decompression mapping for a decoder of the autoencoder representing weight adjustments to the LSTM neurons of the decoder, wherein each weight adjustment to the LSTM neurons corresponds to a loss function value from comparing a data point input into the encoder to an output data point from the decoder; and
determining, by the one or more processors, an anomaly detection threshold based on a distribution of the loss function values.

17. The method of claim 16, further comprising:
iteratively adjusting, by the one or more processors, the anomaly detection threshold as a hyperparameter of the autoencoder, and wherein the anomaly detection threshold is set to a value corresponding to a plurality of standard deviations away from a mean loss function value.

18. The method of claim 16, further comprising:
generating, by the one or more processors, additional electrochemical data for inclusion as part of (i) the set of non-anomalous electrochemical data or (ii) a set of anomalous electrochemical data using a generative adversarial network (GAN).

19. The method of claim 13, wherein the autoencoder includes one or more dropout layers between LSTM neuron layers, wherein at least one dropout layer has a dropout rate between 5% to 20%, wherein the electrochemical data is a first set of electrochemical data, and wherein the method further comprises:
training, by the one or more processors, the autoencoder for a plurality of epochs;
iteratively applying, by the one or more processors, the autoencoder to a second set of electrochemical data to determine a predictive distribution of the autoencoder, wherein each iterative application of the autoencoder utilizes a different subset of LSTM neurons;
determining, by the one or more processors, a final loss value based on a mean and a variance of the predictive distribution; and
determining, by the one or more processors, an anomaly detection threshold based on the final loss value, wherein determining whether the first set of electrochemical data includes the anomaly is based on the anomaly detection threshold.

20. A non-transitory computer-readable medium, comprising executable instructions that, when executed by one or more processors, cause the one or more processors to perform actions comprising:
receiving electrochemical data corresponding to concentration levels of a chemical sample;
applying an autoencoder to the electrochemical data to determine whether the electrochemical data includes an anomaly related to the chemical sample, the autoencoder having one or more long short-term memory (LSTM) neurons; and
responsive to determining that the electrochemical data includes the anomaly, generating an alert for display to a user, the alert indicating that the anomaly is present.
